(19) United States
(12) Patent Application Publication
(10) Pub. No.: US 2026/0133411 A1
(43) Pub. Date: May 14, 2026

(54) SPATIAL FILTER FOR STRUCTURED ILLUMINATION MICROSCOPY

(71) Applicant: The University of British Columbia, Vancouver (CA)

(72) Inventors: Keng CHOU, Vancouver (CA); Youchang ZHANG, Vancouver (CA)

(21) Appl. No.: 19/367,407

(22) Filed: Oct. 23, 2025

Related U.S. Application Data
(63) Continuation of application No. PCT/CA2024/050541, filed on Apr. 24, 2024.
(60) Provisional application No. 63/461,412, filed on Apr. 24, 2023.

(51) Int. Cl. G02B 21/00; G02B 26/04

(52) U.S. Cl. CPC G02B 21/0032; G02B 26/04

(57) ABSTRACT

A spatial filter for a confocal microscope comprising a spinnable disk locatable in an optical path of the confocal microscope between a coherent light source providing excitation light and a target. The spinnable disk comprises a first region providing a first optical path through the disk, the first region comprising a first optical path length for the excitation light transmitted through the disk and a second region providing a second optical path through the disk, the second region comprising a second optical path length for the excitation light transmitted through the disk, the second optical path length different from the first optical path length and thereby imparting a second phase shift to the excitation light transmitted through the second region that is different from a first phase shift imparted to the excitation light transmitted through the first region.

### CROSS-REFERENCE TO RELATED APPLICATIONS

This application is a continuation of Patent Cooperation Treaty application No. PCT/CA 2020/050541 having an international filing date of 24 Apr. 2024 and entitled SPATIAL FILTER FOR STRUCTURED ILLUMINATION MICROSCOPY, which in turn claims priority from, and the benefit under 35 U.S.C. § 119 in relation to, US application No. 63/461,412 filed 24 Apr. 2023 and entitled STRUCTURED ILLUMINATION MICROSCOPY WITH A PHASE-MODULATED SPINNING DISK FOR 3D OPTICAL SECTIONING. All of the applications referred to in this paragraph are hereby incorporated herein by reference for all purposes.

### FIELD

This invention relates to apparatus and methods for structured illumination microscopy (SIM). Aspects of the invention relate to spatial filters for use in SIM, and in particular embodiments, phase-modulating spinnable disk spatial filters for use in SIM, and methods for modulating phase of light transmitted through the spatial filter.

### BACKGROUND

Fluorescence microscopy is a popular technique for visualizing cellular structures because of its high specificity and minimal invasiveness. However, the spatial resolution of traditional fluorescence microscopy is limited to about 250 nm by the diffraction limit of light.

Various techniques have been proposed to improve the resolution of microscope systems beyond the diffraction limit. These techniques are generally referred to as “super-resolution microscopic techniques”.

One super-resolution microscopic technique is single-molecule localization microscopy (SMLM). SMLM has a high spatial resolution (about 10-20 nm) but SMLM is slow as it requires tens of thousands of images to reconstruct a single super-resolution image.

Another super-resolution microscopic technique is stimulated emission depletion microscopy (STED). STED scans samples point by point. STED is faster than SMLM (typically at about 5 Hz) with a resolution of about 50-100 nm. However, STED is typically compromised by higher phototoxicity.

Another super-resolution microscopic technique is structured illumination microscopy (SIM). SIM projects a pattern of structured illumination onto a sample and the resulting fluorescence or reflected light is collected to be processed and/or analyzed to reveal properties of the sample in resolutions beyond the diffraction limit of conventional microscopy. Compared to SMLM and STED, traditional SIM techniques typically exhibit a lower resolution (about 120 nm). However, SIM can achieve a higher frame rate than SMLM and STED, making SIM attractive for some applications, such as, by way of non-limiting example, super-resolution live-cell imaging.

Typical prior art SIM systems use wide-field illumination patterns produced by the interference of two laser beams to illuminate a sample. However, the wide-field illumination patterns used in SIMs are limited in certain ranges of spatial frequencies. This limitation compromises the optical sectioning capability of conventional SIM systems. This limitation is commonly referred to as the “missing cone” problem (the portions of spatial frequencies not effectively captured by conventional SIMs are cone-shaped in the Fourier space). As a result, when reconstructing images from conventional SIM data, information about structures oriented in the direction of the missing cone may be lost or misrepresented, leading to reduced image quality and resolution in certain directions.

Some approaches have been proposed to enhance the optical sectioning capability of SIM. One approach is referred to as 3D SIM. 3D SIM addresses the “missing cone” problem by using an illumination pattern produced by a three-beam interference. However, 3D SIM requires more raw images for image reconstruction, which makes it more susceptible to sample motion. Moreover, although 3D SIM fills the missing cone, it is unable to physically reject out-of-focus signals. Therefore, its capability for optical sectioning is limited.

Another approach proposed to enhance the optical sectioning capability of SIM is spot-scanning SIM. A common spot-scanning SIM technique is known as instant SIM or iSIM, Spot-scanning SIM spatially rejects the out-of-focus signal using a combination of a pinhole array and two micro-lens arrays. This analog implementation of SIM based on spot-scanning confocal microscopy provides a good optical sectioning capability and increases the frame rate to about 100 Hz. However, the resolution of spot-scanning SIM is degraded compared to conventional SIM. The reason for the degradation is that conventional SIM illuminates the sample with a sharper interference pattern, but the illumination spot of spot-scanning SIM uses the Airy pattern.

In conventional SIM systems, the background signals coming from out-of-focus fluorophores (i.e. out-of-focus signals) often obscure the in-focus signals and result in lower contrast. The effect of out-of-focus signals on the SIM images is particularly noticeable for thick samples.

Optical-sectioning SIM (OS-SIM) has been proposed to reduce the background noise by exploiting the fact that the spatial frequencies of the out-of-focus signals quickly approach zero when defocused. However, as structured illumination downshifts the high-frequency signals into the passband of the wide-field optical transfer function (OTF), the desired high-frequency signals are mixed with the low-frequency background noise in the spatial frequency domain. Therefore, attenuating the low-frequency background also discards the high-frequency signals and comprises the resolution improvement provided by the SIM system. For this reason, OS-SIM is typically used for background noise removal instead of resolution improvement.

There is a desire for SIM systems and methods that improve upon prior art SIM techniques and/or ameliorate any of the drawbacks with prior art SIM techniques.

### SUMMARY

One aspect of the invention provides a spatial filter for a confocal microscope. The spatial filter comprises: a disk spinnable about a spinning axis in an optical path of the confocal microscope between a coherent light source providing excitation light and a target. The spinnable disk comprises: a first region providing a first optical path through the disk, the first region comprising a first optical path length for transmission of the excitation light through the disk; and a second region providing a second optical path through the disk, the second region comprising a second optical path length for transmission of the excitation light through the disk. The second optical path length is different from the first optical path length and thereby imparts a second phase shift to the excitation light transmitted through the second region that is different from a first phase shift imparted to the excitation light transmitted through the first region.

Another aspect of the invention provides a spatial filter for a confocal microscope. The spatial filter comprises: a spinnable disk locatable for spinning about a spinning axis in an optical path of the confocal microscope between a coherent light source and a target. The spinnable disk comprises: a first region providing a first optical path through the disk the first region comprising a corresponding first effective index of refraction; and a second region providing a second optical path through the disk the second region comprising a corresponding second effective index of refraction different from the first effective index of refraction; wherein the first and second regions modulate the phase of light transmitted through the disk.

Another aspect of the invention provides a method for confocal microscopy. The method comprises: locating a spatial filter as set out herein in the optical path of a microscope system between a coherent light source and a target; and spinning the disk about a spinning axis that is coaxial with an optical axis of the microscope system.

The disk may be located on a focal plane of the objective lens of a microscope system.

Another aspect of the invention provides a spinnable disk confocal microscope comprising the spatial filter as set out herein.

The first region may comprise a first index of refraction and the second region may comprise a second index of refraction, the second index of refraction different from the fist index of refraction.

The first region may comprise a first geometric path length and the second region may comprise a second geometric path length, the second geometric path length different from the first geometric path length.

The first optical path may comprise a first effective index of refraction for transmission of the excitation light therethrough and the second optical path may comprise a second effective index of refraction for transmission of the excitation light therethrough, the second effective index of refraction different from the first effective index of refraction.

The first effective index of refraction may be based on one or more indices of refraction corresponding to one or more portions of the first optical path and the second effective index of refraction may be based on one or more indices of refraction corresponding to one or more portions of the second optical path. The at least one index of refraction of the one or more indices of refraction of the first optical path may be different from at least one index of refraction of the one or more indices of refraction of the second optical path.

The first effective index of refraction may be based on one or more geometric path lengths corresponding to one or more portions of the first optical path and the second effective index of refraction may be based on one or more geometric path lengths corresponding to one or more portions of the second optical path. At least one geometric path length of the one or more geometric path lengths of the first optical path may be different from at least one geometric path length of the one or more geometric path lengths of the second optical path.

The first region may be spatially periodic in at least a first direction orthogonal to the spinning axis.

The second region may be spatially periodic in at least a second direction orthogonal to the spinning axis.

The first region may be spatially periodic in a third direction orthogonal to both the spinning axis and the first direction.

The second region may be spatially periodic in a fourth direction orthogonal to both the spinning axis and the second direction.

The first and second directions may be parallel and the third and fourth directions may be parallel.

A phase difference between the first phase shift to the excitation light and the second phase shift to the excitation light may be in a range of about 135° to about 225°, preferably in a range of 165°-195°, 175°-185° or 180°.

A 0^{th}-order diffraction beam of the excitation light transmitted through the disk may be cancelled or substantially attenuated due to the phase difference between the first phase shift to the excitation light and the second phase shift to the excitation light.

A plurality of 1^{st}-order diffraction beams of the excitation light may be transmitted through the disk to an objective lens of the microscope system.

Interference of the plurality of 1^{st}-order diffraction beams of the excitation light, after transmission through the objective lens, may generate a structured illumination pattern on the target. The structured illumination pattern may comprise a lattice illumination pattern comprising spatially periodic illumination maxima.

The first region may comprise a plurality of first sub-regions, preferably a spatially periodic plurality of first sub-regions in at least one direction orthogonal to the spinning axis, wherein each first sub-region: provides a corresponding first sub-region optical path through the disk; and has the first optical path length.

Each first sub-region may comprise a corresponding first sub-region pinhole extending through at least one first layer of the disk.

Each first sub-region may have a shape that is either circular or polygonal in a plane orthogonal to the spinning axis.

The second region may comprise a plurality of second sub-regions, preferably a spatially periodic plurality of second sub-regions in at least one direction orthogonal to the spinning axis, wherein each second sub-region: provides a corresponding second sub-region optical path through the disk; and has the second optical path length.

Each second sub-region may comprise a corresponding second sub-region pinhole extending through the at least one first layer of the disk.

Each second sub-region may have a shape that is either circular or polygonal in a plane orthogonal to the spinning axis.

A number of second sub-region pinholes may be equal to a number of first sub-region pinholes.

Each first sub-region may comprise an additional first sub-region pinhole through a second layer of the disk, the second layer of the disk different from the first layer of the disk.

The disk may comprise a substrate layer transparent to the excitation light from the light source.

The substrate layer may extend across this disk in directions orthogonal to the spinning axis such that the substrate layer is present in both the first optical path and the second optical path.

The substrate layer may comprise an optically flat fused silica substrate.

The first layer may be deposited on the substrate layer and may be opaque to the excitation light.

A ratio of a combined area of the first and second sub-region pinholes in a plane orthogonal to the spinning axis to an area of the first layer in the plane orthogonal to the spinning axis is in a range of: 5%-40%, preferably 10%-30%.

The first layer may be made of metal or metal alloy. The first layer may be made of aluminum.

Each of the plurality of first sub-regions may have a dimension factor w₁ defined by a dimension of the corresponding first sub-region pinhole through the first layer in a plane orthogonal to the spinning axis. Each of the plurality of second sub-regions may have a dimension factor w₂ defined by a dimension of the corresponding second sub-region pinhole through the first layer in a plane orthogonal to the spinning axis.

The first and second regions may have respective spatial periods of d₁ and d₂ in directions orthogonal to the spinning axis.

A plurality of 1^{st}-order diffraction beams of the excitation light may be transmitted through the disk to an objective lens of the microscope system. The plurality of 1^{st}-order diffraction beams may comprise four 1^{st}-order diffraction beams corresponding to four Fourier peaks of the spatial periodicity of the first and second regions.

Any adjacent pair of first sub-regions may be separated by a distance d₁ in a first direction orthogonal to the spinning axis. Any adjacent pair of second sub-region may be separated by a distance d₂ in a second direction orthogonal to the spinning axis.

An amount of out-of-focus signals in the sampled light blocked by the first layer may be inversely correlated to at least one of: a first opening ratio w₁/d₁; and a second opening ratio w₂/d₂.

At least one of the first and second opening ratios may be less than 0.5.

An amount of out-of-focus signals in the sampled light blocked by the first layer may be greater than 50%.

The second layer may be made of a transparent material having a second layer index of refraction.

An index of refraction in the additional first sub-region pinholes may be different than the second layer index of refraction, thereby imparting a phase shift to the excitation light transmitted through the additional first sub-region pinholes that is different from a phase shift imparted to the excitation light transmitted through the second layer.

Each first sub-region may be defined at least in part by a corresponding additional first sub-region pinhole through the second layer and a corresponding first sub-region pinhole through the first layer to provide the first optical path.

Each second sub-region may be defined at least in part by a corresponding portion of the second layer and a corresponding second sub-region pinhole through the first layer to provide the second optical path.

The second layer may be made of a material from one or more of: film polymer or liquid crystal.

The disk may be locatable in the optical path of the confocal microscope wherein the spinning axis is co-axial with an optical axis of the microscope.

The disk may be locatable on a focal plane of the objective lens of the confocal microscope.

Another aspect of the invention provides a spatial filter for a microscopy system. The spatial filter comprises a spinning disk. The disk comprises: a substrate; a first layer deposited on the substrate, wherein the first layer comprises a plurality of pinholes; and, a second layer deposited on the first layer, wherein the second layer comprises a film material having properties that affect the phase of transmitted light, and wherein the second layer is deposited on the first layer in an arrangement that causes the light transmitted through the disk to undergo a phase modulation.

The phase modulation may comprise a phase shift in a range of about 135° to about 225°, preferably in a range of 165°-195°, 175°-185° or 180°.

The phase modulation may comprise a cancellation or attenuation of 0^{th}-order light.

The phase modulation may create a 2D lattice illumination pattern produced by an interference of four first-order light beams.

The disk may be integrated into a wide-field microscopy system comprising an objective lens with a focal plane. The disk may be positioned in the focal plane.

The first layer may be fabricated from any material that changes the transmission of light, including but not limited to, metals, such as aluminum, gold, and silver, and non-metals, such as liquid crystals, and polarization-sensitive polymers.

The substrate and the first layer may be combined into one piece to produce one metal disk with pinholes.

The pinholes may be polygonal or circular. The pinholes may be triangles, squares, hexagons, octagons or decagons.

The distance between each pinhole in the plurality of pinholes may create an interference pattern on a sample.

The surface area of the plurality of pinholes may comprise 0%-99% of a disk surface area.

The surface area of the plurality of pinholes may comprise 50%-99% of a disk surface area.

The surface area of the plurality of pinholes may comprise 80% of a disk surface area.

The second layer may modulate the phase of light on a sample.

The second layer may produce an illumination pattern on a sample.

The second layer may comprise a polymer or liquid crystal.

The second layer may be transparent, or nearly transparent.

The second layer my cover 40%-60% of the pinholes in the plurality of pinholes.

Another aspect of the invention provides a method for fabricating a spinning disk for a spatial filter. The method comprises: coating a layer of photoresist on the optically flat fused silica substrate; curing the photoresist by patterned light using a photomask, or by maskless photolithography; developing the photoresist using a developer solution; depositing an aluminum layer onto the substrate by physical vapor deposition; removing the exposed photoresist, and the aluminum deposited on the exposed photoresist, creating pinholes; coating a layer of photoresist on the aluminum layer; curing the photoresist by patterned light using a photomask, or by maskless photolithography; developing the photoresist using a developer solution; removing the exposed photoresist, and the film material deposited on the exposed photoresist, creating pinholes.

Coating at least portion of the aluminum layer with the film material may comprise coating every other pinhole in the plurality of pinholes with the film material.

Aspects of the invention provide apparatus having any new and inventive feature, combination of features, or sub-combination of features as described herein.

Aspects of the invention provide methods having any new and inventive steps, acts, combination of steps and/or acts or sub-combination of steps and/or acts as described herein.

It is emphasized that the invention relates to all combinations of the above features, even if these are recited in different claims.

Further aspects and example embodiments are illustrated in the accompanying drawings and/or described in the following description.

### BRIEF DESCRIPTION OF THE DRAWINGS

The accompanying drawings illustrate non-limiting example embodiments of the invention.

FIG. 1 is a schematic diagram of a microscope system incorporating a spatial filter according to an example embodiment.

FIG. 2A is a plan view of a phase-modulating spinnable disk according to a non-limiting example embodiment.

FIG. 2B is a cross-sectional view of the disk shown in FIG. 2A taken along lines 2B-2B of FIG. 2A.

FIG. 3A is a plan view of a phase-modulating spinnable disk according to another example embodiment.

FIG. 3B is a cross-sectional view of the disk shown in FIG. 3A taken along lines 3B-3B of FIG. 3A.

FIG. 4 is a schematic diagram showing an SIM system incorporating a spatial filter according to an example embodiment.

FIG. 5 is a schematic diagram of a plan view of a back pupil of the objective lens shown in FIG. 4 according to an example embodiment.

FIG. 6 is a Fourier transform of an illumination pattern of the FIG. 4 SIM system in the spatial frequency domain in the fₓ-f_{y} plane according to an example embodiment.

FIG. 7 is a flowchart of a method for confocal microscopy according to an example embodiment. FIG. 8A is an image of an example optical transfer function (OTF) of a wide-field microscopy system.

FIG. 8B is an image of an example OTF of a SIM system incorporating a phase-modulating spinnable disk according to an example embodiment.

FIG. 8C is an image of an example OTF slice of the FIG. 8A example OTF.

FIG. 8D is an image of an example OTF slice of the FIG. 8B example OTF.

FIG. 9A is an example image of fluorescent beads generated by a wide-field microscopy system.

FIG. 9B is an example image of fluorescent beads generated by a SIM system incorporating a phase-modulating spinnable disk according to an example embodiment.

FIG. 9C is an intensity plot of region 1 shown in FIGS. 9A and 9B.

FIG. 9D is an intensity plot of region 2 shown in FIGS. 9A and 9B.

FIG. 10A is an example wide-field microscopy fluorescence image of ryanodine receptors in rat cardiac myocytes.

FIG. 10B is an example fluorescence image of ryanodine receptors in a rat cardiac myocytes obtained using a SIM system incorporating a phase-modulating spinnable disk according to an example embodiment.

FIG. 10C shows enlarged views of regions 1-4 shown in FIGS. 10A and 10B.

FIG. 11 is a schematic depiction of a simulation of a portion of the normalized intensity of the structured illumination (e.g. lattice) pattern generated by the FIG. 4 SIM system on a sample plane of the target.

### DETAILED DESCRIPTION

Throughout the following description, specific details are set forth in order to provide a more thorough understanding of the invention. However, the invention may

be practiced without these particulars. In other instances, well known elements have not been shown or described in detail to avoid unnecessarily obscuring the invention. Accordingly, the specification and drawings are to be regarded in an illustrative, rather than a restrictive sense.

Aspects of the invention provide spatial filters for confocal microscope systems (e.g. structured illumination microscope (SIM) systems) and microscope systems incorporating same. The spatial filters comprise a spinnable disk locatable in a microscope optical path of the confocal microscope between a coherent light source providing excitation light and a target. The spinnable disk comprises a first region providing a first optical path through the disk wherein the first region comprises a corresponding first optical path length for the excitation light transmitted through the disk and a second region providing a second optical path through the disk wherein the second region comprises a corresponding second optical path length for the excitation light transmitted through the disk. The first and second optical path lengths are different from one another, thereby respectively imparting different first and second phase shifts to excitation light transmitted through the first and second regions. The first and second regions modulate the phase of light transmitted through the disk by introducing different phase shifts to the excitation light depending on the optical path through which the excitation light is transmitted through the disk.

The different first and second optical path lengths may be provided by the first and second regions comprising corresponding first and second indices of refraction that are different from one another and/or corresponding first and second geometric path lengths that are different from one another. The different first and second optical path lengths may be provided by the first and second regions comprising corresponding first and second effective indices of refraction that are different from one another. The different first and second effective indices of refraction may be provided by portions of the first and second paths that have different indices of refraction from one another and/or by portions of the first and second paths that have different geometric path lengths than one another. The spinnable disk may modulate the phase of light transmitted through the disk such that the 0^{th}-order diffraction beam is cancelled or substantially attenuated. The spinnable disk may modulate the phase of light transmitted through the disk to transmit a plurality of 1^{st}-order diffraction beams.

Other aspects of the invention provide methods for confocal microscopy comprising locating the spatial filters described herein in the microscope optical path between the coherent light source and the sample; and spinning (rotating) the disk about an axis parallel with the microscope optical path.

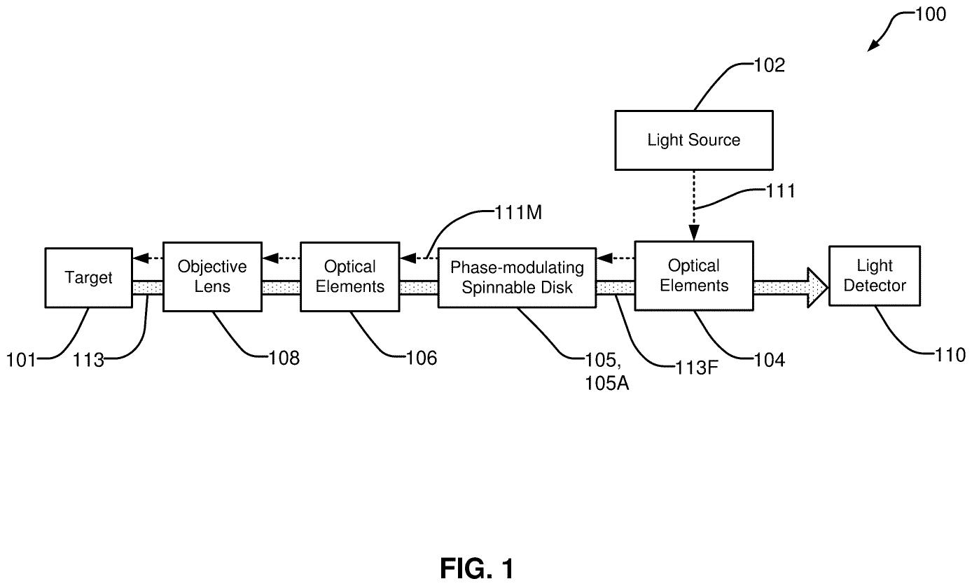

FIG. 1 is a schematic diagram showing a microscope system 100 incorporating a spatial filter 105 according to an example embodiment. Microscope system 100 comprises a light source 102 configured to emit an excitation light 111. In some embodiments, light source 102 comprises a coherent light source and/or light from light source is suitably filtered to provide coherent excitation light 111. In some embodiments, light source 102 comprises a laser or lasers. In some embodiments, light source 102 comprises one or more light emitting diodes (LEDs). In some embodiments, excitation light 111 has a wavelength in the range of about 400 nm to 700 nm, although other wavelengths could additionally or alternatively be used. In a non-limiting example embodiment, excitation light 111 has a wavelength of about 488 nm.

In an excitation path of system 100, excitation light 111 is directed by optical elements 104 to a spatial filter 105. In some embodiments, optical elements 104 may comprise one or more lenses, one or more mirrors, a ¼ wave plate (e.g. to circularly polarize excitation light 111), a beam splitter and/or the like). Spatial filter 105 is configured to modulate the phase of light (e.g. excitation light 111) transmitted through the spatial filter in the excitation path of system 100. In some embodiments, spatial filter 105 comprises a phase-modulating spinnable disk 105A (often referred to herein as “disk” 105A, for brevity).

Spatial filter 105 introduces phase modulation to excitation light 111 transmitted therethrough. In some embodiments, spatial filter 105 modulates the phase of excitation light 111 transmitted through spatial filter 105 to cancel or substantially attenuate the 0^{th}-order diffraction beam of the light transmitted through the spatial filter. In some embodiments, spatial filter 105 modulates the phase of light transmitted through spatial filter 105 to generate a plurality of 1^{st}-order diffraction

beams. In some embodiments, the plurality of 1^{st}-order diffraction beams comprises four 1^{st}-order diffraction beams. In some embodiments, spatial filter 105 comprise a spinnable disk 105A locatable in an optical path of system 100 between light source 102 and a target 101 wherein spinnable disk 105A comprises a first region providing a first optical path through the disk wherein the first region comprises a first optical path length for excitation light 111 transmitted through the disk and a second region providing a second optical path through the disk wherein the second region comprises a second optical path length for excitation light 111 transmitted through the disk. The first and second optical path lengths are different from one another, thereby respectively imparting different first and second phase shifts to excitation light 111 transmitted through the first and second regions.

As is known to those of skill in the art, optical path length is the length that light needs to travel through a vacuum to create the same phase difference as it would have when traveling through a given medium and may be calculated by taking the product of the geometric length of the optical path followed by light and the refractive index of the medium through which the light ray propagates.

The different first and second optical path lengths of the first and second regions and/or the first and second optical paths may be provided by the first and second regions comprising corresponding first and second indices of refraction that are different from one another and/or corresponding first and second geometric path lengths that are different from one another. The different first and second optical path lengths of the first and second regions and/or the first and second optical paths may be provided by the first and second regions comprising corresponding first and second effective indices of refraction that are different from one another. An “effective index of refraction” of an optical path described herein refers to an index of refraction that corresponds to the overall phase shift on the light transmitted through the corresponding optical path. The different first and second effective indices of refraction may be provided by portions of the first and second paths that have different indices of refraction from one another and/or by portions of the first and second paths that have different geometric path lengths than one another. In some embodiments, the first effective index of refraction is based on one or more indices of refraction and/or one or more geometric path lengths corresponding to one or more portions of the first optical path and the second effective index of refraction is based on one or more indices of refraction and/or one or more geometric path lengths corresponding to one or more portions of the second optical path wherein at least one index of refraction and/or geometric path length of the one or more indices of refraction and/or geometric path lengths of the first optical path is different from at least one index of refraction and/or geometric path length of the one or more indexes of refraction and/or geometric path lengths of the second optical path. Phase-modulated excitation light 111M is then directed by optical elements 106 to an objective lens 108. Phase-modulated excitation light 111M is projected onto target 101 (e.g. a sample) by objective lens 108. In some embodiments, spatial filter 105 is located on a focal plane of objective lens 108. In some embodiments, phase-modulated excitation light 111M is projected onto target 101 in an interference pattern. In some embodiments, the interference pattern projected onto target 101 comprises a structured illumination pattern. In some embodiments, the structured illumination pattern comprises a lattice illumination pattern comprising spatially periodic illumination maxima. In some embodiments, the interference pattern projected onto target 101 is generated from the interference of a plurality of 1^{st}-order diffraction beams of the phase-modulated excitation light 111M transmitted through spatial filter 105.

Phase-modulated excitation light 111M interacts with target 101 to generate sampled light 113. As is known to those of skill in the art, sampled light 113 typically comprises in-focus signals and out-of-focus signals. In a collection path of system 100, sampled light 113 is collected by objective lens 108 and then directed by optical elements 106 back to spatial filter 105. Spatial filter 105 is configured to filter sampled light 113 in the collection path of system 100. Since sampled light 113 is incoherent, the image formed by sampled light on detector 110 (described in more detail below) is not impacted by the phase modulation introduced by spatial filter 105. In some embodiments, spatial filter 105 filters sampled light 113 by rejecting out-of-focus signals of sampled light 113 and transmitting in-focus signals. In some embodiments, a portion of the surface area of spatial filter 105 is coated with a suitable material of sufficient opacity (e.g. aluminum, gold, silver, etc.) which rejects out-of-focus signals in sampled light 113 by physically blocking at least portions of the out-of-focus signals. In some embodiments, this portion of the surface area of spatial filter 105 is greater than 50%. In some embodiments, this portion of the surface area of spatial filter 105 is greater than 75% and spatial filter 105 rejects more than 75% of the out-of-focus signals of sampled light 113.

Filtered sampled light 113F is then directed by optical elements 104 to a light detector 110 configured to collect filtered sampled light 113F. In some embodiments, light detector 110 comprises a camera. Collected filtered sampled light 113F may be further processed by any suitable processing techniques for any suitable purposes, for example, to generate images (e.g. fluorescence images) as is known in the art.

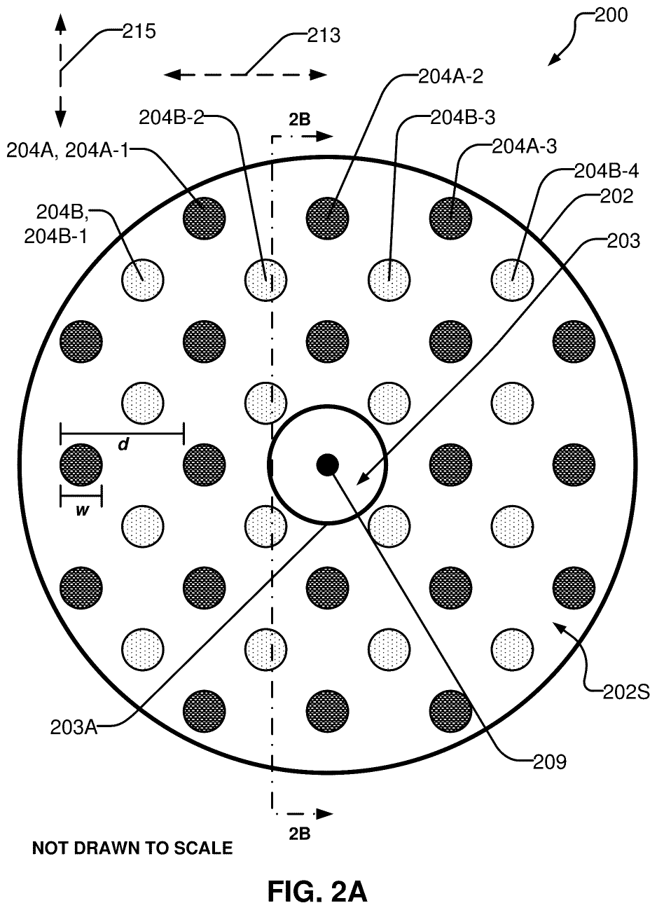

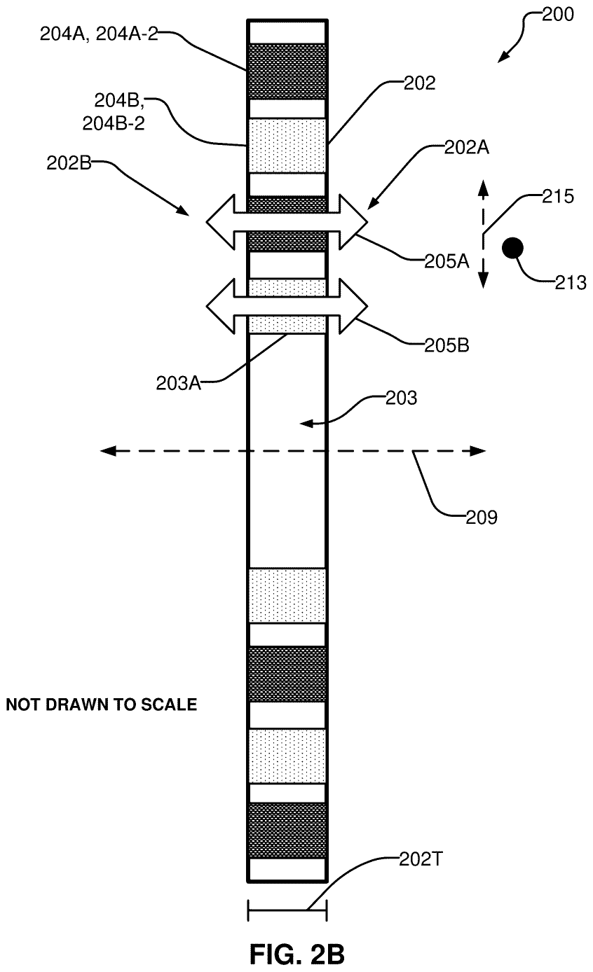

FIG. 2A is a plan view of a disk 200 according to a non-limiting example embodiment. FIG. 2B is a cross-sectional view of disk 200 taken along lines 2B-2B of FIG. 2A. FIGS. 2A and 2B (collectively, FIG. 2) are presented for illustrative purposes only and are not drawn to scale. Disk 200 may be incorporated into any spatial filter disclosed herein (e.g. spatial filters 105, 405, etc.).

Disk 200 comprises a body 202. Body 202 of the illustrated embodiment extends in orthogonal transverse directions 213 and 215 from spinning axis 209 and spans an area 202S in a plane orthogonal to a spinning axis 209 and extends longitudinally in a direction parallel to spinning axis 209 to define a thickness 202T (shown in FIG. 2B). In some embodiments, spinning axis 209 is co-axial with an optical axis of a microscope system incorporating disk 200 (e.g. microscope systems 100, 400 described herein). While the thickness 202T of disk 200 is shown as being uniform in the FIG. 2B embodiment, this is not necessary and the thickness of disk 200 may vary with its transverse extension (in directions 213 and 215) from spinning axis 209. Spinning axis 209 extends into and out of the page in FIG. 2A. Disk 200 of the illustrated FIG. 2 embodiment is shaped to define a through-bore 203 extending through body 202 in a direction parallel to spinning axis 209. A shaft (not shown in FIG. 2) may extend into and through through-bore 203 such that an outer (e.g. circumferential or keyed circumferential) surface of the shaft bears against an inner surface 203A of through-bore 203 to facilitate engagement between the shaft and disk 200. In some embodiments, disk 200 is rotatable about spinning axis 209, for example, through the rotation of the shaft. In other embodiments, any other suitable mechanism(s) may be used to support disk 202 for rotation about spinning axis 209.

In FIG. 2, disk 200 comprises a body 202 that is circularly shaped in a plane orthogonal to spinning axis 209. However, this is not necessary. Body 202 may be of any suitable shapes. In some embodiments, body 202 has a polygonal shape in a plane orthogonal to spinning axis 209.

Disk 200 of the FIG. 2 embodiment comprises a first region 204A configured to provide a first optical path through disk 200. First region 204A comprises a corresponding first optical path length through disk 200 and causes a corresponding first phase shift (also referred to as a phase offset) to coherent light (e.g. excitation light 111 from light source 102 of microscope system 100) that passes through disk 200 via first region 204A. In the case of the illustrated FIG. 2 embodiment, first region 204A comprises a first material having a corresponding first index of refraction which impacts the optical path length through first region 204A. In some embodiments, the first optical path length of first region 204A and corresponding first phase shift may additionally or alternatively be effected by varying the geometric length of first region 204A through disk 200. In some embodiments, first region 204A comprises a plurality of first sub-regions 204A-1, 204A-2, 204A-3, . . . , 204A-N, etc. First sub-regions 204A-1, 204A-2, 204A-3, etc., together form first region 204A. Each of first sub-regions 204A-1, 204A-2, 204A-3, etc. may have the same first optical path length through disk 200 and thereby cause the same phase shift to coherent light (e.g. excitation light 111 from light source 102 of microscope system 100) that passes through disk 200 via first sub-regions 204A-1, 204A-2, 204A-3, etc.

In some embodiments, first region 204A and/or any of the first sub-regions 204A-N extend in directions 213 and 215 to span an area in a plane orthogonal to spinning axis 209. In some embodiments, first region 204A and/or any of the first sub-regions 204A-N extends in a direction parallel to or substantially parallel to spinning axis 209 to extend between a first disk side 204A and a second disk side 202B (shown in FIG. 2B). First region 204A provides a first optical path through disk 200 by permitting light to be transmitted between first disk side 202A and second disk side 202B (shown in FIG. 2B) through first region 204A and/or any of the first sub-regions 204A-N. One example first optical path 205A is shown in FIG. 2B and illustrated as a double-headed arrow. Light transmitted through disk 200 through first region 204A diffracts in a first diffractive manner based on the first index of refraction.

Disk 200 comprises a second region 204B configured to provide a second optical path through disk 200. Second region 204B comprises a second optical path length through disk 200 and causes a corresponding second phase shift to coherent light (e.g. excitation light 111 from light source 102 of microscope system 100) that passes through disk 200 via second region 204B. The first and second optical path lengths of first region 204A and second region 204B and the corresponding phase shifts imparted on coherent light transmitted therethrough may be different from one another. In the case of the illustrated FIG. 2 embodiment, second region 204B comprise a second material having a corresponding second index of refraction which impacts the optical path length through second region 204B and which is different from the index of refraction of first region 204A. In some embodiments, the second optical path length of second region 204B and corresponding second phase shift (which may be selected to be different from the first optical path length and first phase shift) may additionally or alternatively be effected by varying the geometric length of second region 204B through disk 200. In some embodiments, second region 204B comprises a plurality of second sub-regions 204B-1, 204B-2, 204B-3, . . . , 204B-N, etc. Second sub-regions 204B-1, 204B-2, 204B-3, etc. together form second region 204B. Each of second sub-regions 204B-1, 204B-2, 204B-3, etc. may have the same second optical path length through disk 200 and thereby cause the same phase shift to coherent light (e.g. excitation light 111 from light source 102 of microscope system 100) that passes through disk 200 via second sub-regions 204B-1, 204B-2, 204B-3, etc.

In some embodiments, second region 204B and/or any of the second sub-regions 204B-N extend in directions 213 and 215 to span an area in a plane orthogonal to spinning axis 209. In some embodiments, second region 204B and/or any of second sub-regions 204B-N extends in a direction parallel to or substantially parallel to spinning axis 209 to extend between first disk side 204A and second disk side 202B (shown in FIG. 2B). Second region 204B provides a second optical path through disk 200 by permitting light to be transmitted between first disk side 202A and second disk side 202B (shown in FIG. 2B) through second region 204B. One example second optical path 205B is in FIG. 2B and illustrated as a double-headed arrow. Light transmitted through disk 200 through second region 204B diffracts in a second diffractive manner based on the second index of refraction.

In some embodiments, first region 204A is spatially periodic in at least a first direction. In some embodiments, the first direction is orthogonal to an optical path of a microscope system (e.g. microscope system 100 or any other microscope systems described herein) and/or to spinning axis 209. For example, in the non-limiting example embodiment of disk 200 in the angular orientation about spinning axis 209 shown in FIG. 2, first region 204A comprises a plurality of first sub-regions 204A-1, 204A-2, 204A-3, etc. spaced apart in direction 213 in periodic intervals (e.g. equal distance of separation between adjacent first sub-regions 204A-N in direction 213) such that first region 204A is spatially periodic in direction 213 where the optical path is parallel to spinning axis 209.

In some embodiments, second region 204B is spatially periodic in a second direction where the second direction is orthogonal to an optical path of a microscope system (e.g. microscope system 100 or any other microscope systems described herein) and/or to spinning axis 209. For example, in the non-limiting example embodiment of disk 200 in the angular orientation about spinning axis 209 shown in FIG. 2, second region 204B comprises a plurality of second sub-regions 204B-1, 204B-2, 204B-3, etc. spaced apart in direction 213 in periodic intervals (e.g. equal distance of separation between adjacent second sub-regions 204B-N in direction 213) such that second region 204B is spatially periodic in direction 213 where the optical path is parallel to spinning axis 209.

In some embodiments, first region 204A is spatially periodic in a third direction where the third direction is orthogonal to an optical path of a microscope system (e.g. microscope system 100 or any other microscope systems described herein) and/or to spinning axis 209. In some embodiments, the third direction in which first region 204A is spatially periodic is also orthogonal to the first direction in which first region 204A is spatially periodic. For example, in the non-limiting example embodiment of disk 200 shown in FIG. 2, first region 204A comprises a plurality of first sub-regions 204A-1, 204A-2, 204A-3, etc. spaced apart in direction 215 in periodic intervals (e.g. equal distance of separation between adjacent first sub-regions 204A-N in direction 215) such that first region 204A is spatially periodic in direction 215 where the optical path is parallel to spinning axis 209. Direction 215 is orthogonal to direction 213.

In some embodiments, second region 204B is spatially periodic in a fourth direction where the fourth direction is orthogonal to an optical path of a microscope system (e.g. microscope system 100 or any other microscope systems described herein) and/or to spinning axis 209. In some embodiments, the fourth direction in which second region 204B is spatially periodic is also orthogonal to the second direction in which second region 204B is spatially periodic. For example, in the non-limiting example embodiment of disk 200 shown in FIG. 2, second region 204B comprises a plurality of second sub-regions 204B-1, 204B-2, 204B-3, etc. spaced apart also in direction 215 in periodic intervals (e.g. equal distance of separation between adjacent second sub-regions 204B-N in direction 215) such that second region 204B is spatially periodic in direction 215 where the optical path is parallel to spinning axis 209.

In some embodiments, first and second regions 204A and 204B are arranged in a manner and the optical path lengths of first and second regions 204A and 204B are selected (e.g. by selection of the first and second indexes of refraction and/or the first and second geometric path lengths) in a manner such that disk 200 causes a 180° phase shift, or nearly a 180° phase shift (e.g. in a range of 135°-225° or 165°-195° in some embodiments), between light transmitted through first region 204A and light transmitted through second region 204B. This 180° phase shift (or near 180° phase shift) may result in the cancellation or at least substantial attenuation of the 0^{th}-order diffraction beam of coherent light (e.g. excitation light 111) transmitted through disk 202. In some embodiments, disk 300 modulates the phase of transmitted coherent light (e.g. excitation light 111) to transmit four 1^{st}-order diffraction beams. In some embodiments, the four 1^{st}-order diffraction beams interfere with one another to result in an interference pattern that is projected on a target (e.g. sample) 101. In some embodiments, the interference pattern projected onto target 101 comprises a structured illumination pattern. In some embodiments, the structured illumination pattern projected onto target 101 comprises a lattice illumination pattern comprising spatially periodic illumination maxima.

In disk 200 of the FIG. 2A illustrated embodiment, first sub-regions 204A and second sub-regions 204B are illustrated as being circularly shaped in a cross-sectional plane orthogonal to spinning axis 209. However, this is not necessary. First sub-regions 204A and second sub-regions 204B may be of any suitable shape in the plane orthogonal to spinning axis 209. In some embodiments, first sub-regions 204A and second sub-regions 204B are of polygonal shapes, including, but not limited to, triangles, squares, hexagons, decagons, etc.

In some embodiments, each of first and second regions 204A, 204B comprises a plurality of pinholes. For example, in some embodiments, each first sub-region 204A-N and each second sub-region 204B-N comprises a pinhole. In some embodiments, each of first and second regions 204A, 204B comprises a pinhole array (e.g. as schematically depicted in FIG. 2A).

In some embodiments, each first sub-region 204A and/or second sub-region 204B has a size defined by a dimension factor w (shown in FIG. 2A), although this is not required. For example, in embodiments where first sub-region 204A or second sub-region 204B is circularly shaped in a plane orthogonal to spinning axis 209, dimension factor w may comprise a diameter of the circle.

In some embodiments, first region 204A and/or second region 204B are defined by a spatial period parameter d (shown in FIG. 2A) corresponding to a distance of separation between each pair of adjacent sub-regions 204A-N or 204B-N in a direction orthogonal to spinning axis 209. In some embodiments, the spatial period parameter d for first region 204A may be the same in the first and third orthogonal directions of periodicity (e.g. in directions 213, 215). In some embodiments, the spatial period parameter d for first region 204A may be different in each of the first and third orthogonal directions of periodicity (e.g. in directions 213, 215). In some embodiments, the spatial period parameter d for second region 204B may be the same in the second and fourth orthogonal directions of periodicity (e.g. in directions 213, 215). In some embodiments, the spatial period parameter d for second region 204A may be different in each of the second and fourth orthogonal directions of periodicity (e.g. in directions 213, 215). A ratio between the dimension factor w and the spatial period parameter d, i.e., w/d, is referred to as the “opening ratio” herein. In one non-limiting example embodiment, the dimension factor w is about 25 μm and the spatial period parameter d is about 70 μm and the opening ratio is about 0.35.

Disk 200 may be fabricated in any suitable manner such that the first optical path length (e.g. effected by the first index of refraction and/or the first geometric path length) of first region 204A is different from the second optical path length (e.g. effected by the second index of refraction and/or the second geometric path length) of second region 204B.

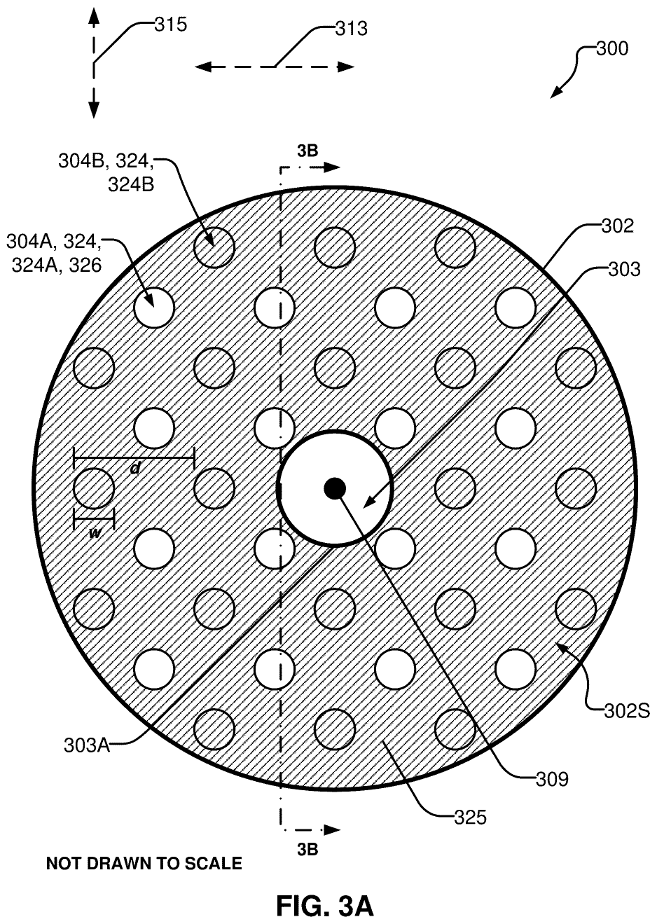

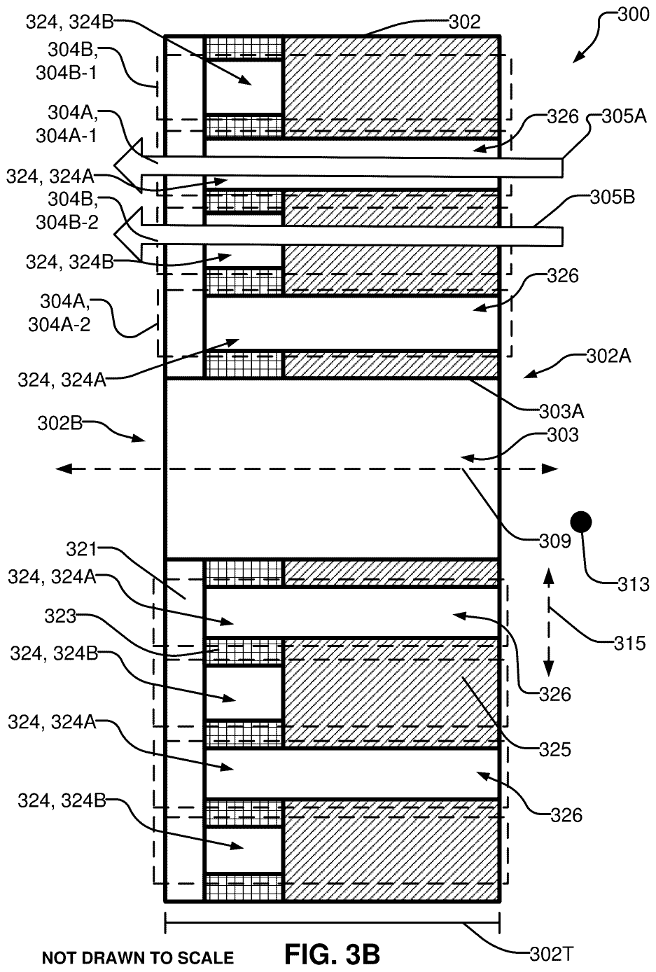

FIG. 3A is a plan view of a disk 300 according to another example embodiment. FIG. 3B is a cross-sectional side view of disk 300 along lines 3B-3B of FIG. 3A. FIGS. 3A and 3B (collectively, FIG. 3) are for illustrative purposes only and are not drawn to scale. Disk 300 may be incorporated into any of the spatial filters disclosed herein (e.g. spatial filters 105, 405, etc.)

Similar to disk 200, disk 300 comprises a body 302 that, in the illustrated embodiment, extends in orthogonal transverse directions 313, 315 from spinning axis 309 and spans an area 302S (shown in FIG. 3A) in a plane orthogonal to spinning axis 309 and extends along spinning axis 309 to define a thickness 302T (shown in FIG. 3B). While the thickness 302T of disk 300 is shown as being uniform in the FIG. 3B embodiment, this is not necessary and the thickness of disk 300 may vary with its transverse extension (in directions 313 and 315) from spinning axis 209. Disk 300 of the illustrated FIG. 3 embodiment is shaped to define a through-bore 303 extending through body 302 in a direction parallel to spinning axis 309. A shaft (not shown in FIG. 3) may extend into and through through-bore 303 such that an outer (e.g. circumferential or keyed circumferential) surface of the shaft bears against an inner surface 303A of through-bore 303 to facilitate engagement between the shaft and disk 300. In some embodiments, disk 300 is rotatable about spinning axis 309, for example, by rotating the shaft. In other embodiments, any other suitable mechanism(s) may be used to support disk 302 for rotation about spinning axis 309.

Referring to FIG. 3B, body 302 comprises a first layer 321 capable of transmitting light (e.g. transparent at the wavelength of light source 102) which provides a substrate for disk 300. In some embodiments, first layer 321 is made of a material and of a construction that primarily transmits light through first layer 321 with low or negligible levels of distortion or scattering. In a non-limiting example embodiment, first layer 321 comprises an optically flat fused silica substrate.

Body 302 comprises a second layer 323 deposited on first layer 321 configured to alter the transmission of light. In some embodiments, second layer 323 is made of an opaque material and/or of a construction that facilitates rejecting out-of-focus signals in a collection path of a microscope system. In some embodiments, second layer 323 is made of metals which may include, but are not limited to, aluminum, gold and silver. In a non-limiting example embodiment, second layer 323 comprises an aluminum layer. In some embodiments, second layer 323 is made of non-metals which may include, but are not limited to, liquid crystals, and polarization-sensitive polymers. In a non-limiting example embodiment, second layer 323 has a thickness of about 120 nm. In some embodiments, second layer 323 and first layer 321 are combined to form a unitary layer.

Second layer 323 of the FIG. 3 embodiment is shaped to define a plurality of pinholes 324 providing corresponding pinhole light paths between first layer 321 and a third layer 325. Each pinhole 324 (together with transparent substrate (first) layer 321) facilitates a corresponding optical path between a first disk side 302A and a second disk side 302B. In some embodiments, pinholes 324 of second layer 323 are fabricated by photolithography. In some embodiments, the plurality of pinholes 324 is spatially periodic (spaced apart in equal intervals) in at least a first direction (e.g. direction 313 or direction 315) which is orthogonal to an optical path of a microscope system (e.g. microscope system 100 or 400) and/or to spinning axis 309 which may be coaxial or parallel with one another. In some embodiments, the plurality of pinholes 324 is spatially periodic in two directions (e.g. direction 313 and direction 315) which may be orthogonal to one another and/or orthogonal to an optical path of a microscope system (e.g. microscope system 100 or 400) and/or to spinning axis 309 which may be coaxial or parallel with one another. In some embodiments, second layer 323 and first layer 321 are combined to form a unitary layer with pinholes 324. In some embodiments, including the illustrated FIG. 3 embodiment, pinholes 324 are empty (e.g. are filled with air). In some embodiments, pinholes 324 and/or portions of pinholes 324 and/or one or more subsets of pinholes 324 and/or portions of one or more subsets of pinholes 324 may be filled with a transparent material. In some embodiments, two groups of pinholes 324 and/or portions of pinholes 324 are filled with different transparent materials having different indices of refraction to thereby provide first and second regions 304A, 304B having first and second different optical path lengths and first and second different phase shifts (phase offsets).

Body 302 of the illustrated FIG. 3 embodiment comprises a third layer 325 deposited on second layer 323. In some embodiments, third layer 325 comprises a transparent material that facilitates the transmission of light therethrough, but which has a different index of refraction from the material in pinholes 324. In some embodiments, third layer 325 comprises polymer film. In a non-limiting example embodiment, third layer 325 has a thickness of about 430 nm.

Third layer 325 of the illustrated FIG. 3 embodiment is shaped to define a plurality of pinholes 326 providing corresponding pinhole light paths between first disk side 302A and second layer 323. In some embodiments, each pinhole 326 is aligned with a pinhole 324 along direction 309. In some embodiments, including in the illustrated embodiment of FIG. 3: a first plurality of second layer pinholes 324 is aligned (in a direction parallel with spinning axis 309) with a corresponding third layer pinhole 326 to provide a first region 304A having a corresponding first optical path length through disk 300 and a corresponding first phase shift; and a second plurality of second layer pinholes 324 is covered (e.g. coated) by transparent third layer 325 to provide a second region 304B having a corresponding second optical path length through disk 300 and a corresponding second phase shift. For example, in the non-limiting example embodiment shown in FIG. 3, first plurality of second layer pinholes 324A (shown as white circles in FIG. 3A) is aligned with a corresponding third layer pinholes 326 and a second plurality of second layer pinholes 324B (shown with the same cross-hatching as third layer 325 in FIG. 3A) is covered by third layer 325. In some embodiments, 50% of second layer pinholes 324 are aligned with a corresponding third layer pinhole 326 and the other 50% of second layer pinholes 324 are covered by third layer 325.

First plurality of second layer pinholes 324A and the corresponding third layer pinholes 326 along with corresponding portions of first layer 321 collectively form first region 304A with a corresponding first optical path length through disk 300 and a corresponding first phase shift. In some embodiments, first region 304A comprises a plurality of first sub-regions 304A-N (e.g. 304A-1, 304A-2, etc.) where each first sub-region 304A-N is formed by a corresponding second layer pinhole 324A, a corresponding third layer pinhole 326 and a corresponding portion of first layer 321.

Second plurality of second layer pinholes 324B and the corresponding portions of third layer 325 along with corresponding portions of first layer 321 collectively form second region 304B with a corresponding second optical path length through disk 300 and a corresponding second phase shift. In some embodiments, the second optical path length through disk 300 and/or the second phase shift are different from the first optical path length through disk 300 and/or the first phase shift of first region 304A. In some embodiments, the difference between the first optical path length through disk 300 and the second optical path length through disk 300 is due to at least in part on the absence of third layer 325 (i.e. third layer pinholes 326) in the corresponding first region 304A and the presence of third layer 325 in the corresponding second region 304B. In general, however, the difference between the first optical path length through disk 300 and the second optical path length through disk 300 may be due to different indices of refraction in the first and second regions 304A, 304B and/or to different geometrical lengths of the optical paths in first and second regions 304A, 304B. In some embodiments, second region 304B comprises a plurality of second sub-regions 304B-N (e.g. 304B-1, 304B-2, etc.) where each second sub-region 304B-N is formed by a corresponding second layer pinhole 324B, a corresponding portion of third layer 325 and a corresponding portion of first layer 321. Light transmitted through first region 304A (an example of which is illustrated as an arrow in FIG. 3B) may be referred to as light 305A. Light transmitted through second region 304B (an example of which is illustrated as an arrow in FIG. 3B) may be referred to as light 305B. Light 305A transmitted from first disk side 302A to second disk side 302B through first region 304A of disk 300 diffracts in a first diffractive manner based on the first optical path length through first region 304A. Light 305B transmitted from first disk side 302A to second disk side 302B through second region 304B of disk 300 diffracts in a second diffractive manner based on the second optical path length through second region 304B. It will be appreciated that the first optical path length through first region 304A and the second optical path length through second region 304B are different from one another and therefore result in different phase shifts (phase modulation) of light that travels through the two regions 304A, 304B. In the case of the illustrated FIG. 3 embodiment, the difference between the first optical path length and the second optical path length is attributable to the difference in index of refraction between first region 304A and second region 304B and, in particular, the difference in index of refraction through third layer 325, where first region 304A includes pinholes 326 (and whatever material might be located in pinholes 326) and second region 304B includes the material of third layer 325. In general, any suitable means may be used to vary the optical path length (and corresponding phase shift) between regions 304A, 304B and to provide corresponding phase modulation. By way of non-limiting example, in some embodiments, the optical path lengths between regions 304A, 304B may be made different by varying an index of refraction between all of part of the path between regions 304A, 304B and/or varying the geometric path length between regions 304A, 304B. Because the first and second optical path lengths through regions 304A, 304B are different from one another, a phase offset is introduced between light 305A and light 305B and light 305A and light 3005B interfere to generate an interference pattern. The interference pattern may comprise constructive interference of some portions of light 305A and 305B and destructive interference of other portions of light 305A and 305B.

In a non-limiting example embodiment, first and second regions 304A and 304B are arranged in a manner and/or the first and second optical path lengths are selected in a manner where disk 300 causes a 180° phase shift or nearly a 180° phase shift (e.g. in a range of 135°-225° or 165°-195° in some embodiments), between light 305A and light 305B transmitted from first disk side 302A to second disk side 302B. Advantageously, the 180° (or near 180°) phase modulation may result in the cancellation or at least substantial attenuation of the 0^{th}-order diffraction beam of light (e.g. excitation light 111) transmitted through disk 300. Interference of light transmitted through disk 300, including cancellation or substantial attenuation of the 0^{th}-order diffraction beam, offer advantages in applications of structured illumination microscopy (SIM) because it improves resolution of the images. In some embodiments, disk 300 modulates the phases of light 305A and 305B to transmit four 1^{st}-order diffraction beams. In some embodiments, the four 1^{st}-order diffraction beams interfere to result in a structured illumination pattern with spatially periodic illumination maxima (e.g. a lattice illumination pattern) on a target (e.g. target 101).

In some embodiments, each first sub-region 304A and/or second sub-region 304B has a size defined by a dimension factor w (shown in FIG. 3A), although this is not required. For example, in embodiments where first sub-region 304A or second sub-region 304B is circularly shaped in a plane orthogonal to spinning axis 309, dimension factor w may comprise a diameter of the circle.

In some embodiments, first region 304A and/or second region 304B are defined by a spatial period parameter d (shown in FIG. 3A) corresponding to a distance of separation between each pair of adjacent sub-regions 304A-N or 304B-N in a direction orthogonal to spinning axis 309. In some embodiments, first region 304A and/or second region 304B may be spatially periodic in two orthogonal directions both of which may be orthogonal to spinning axis 309. In some embodiments, the spatial period parameter may be the same or different for each of these two orthogonal directions. In one non-limiting example embodiment, the dimension factor w is about 25 μm and the spatial period parameter d is about 70 μm and the opening ratio, w/d, is about 0.35. At an opening ratio of about 0.35, second layer 323 of disk 300 is able to reject about 80% of the out-of-focus signals in light transmitting from second disk side 302B to first disk side 302A.

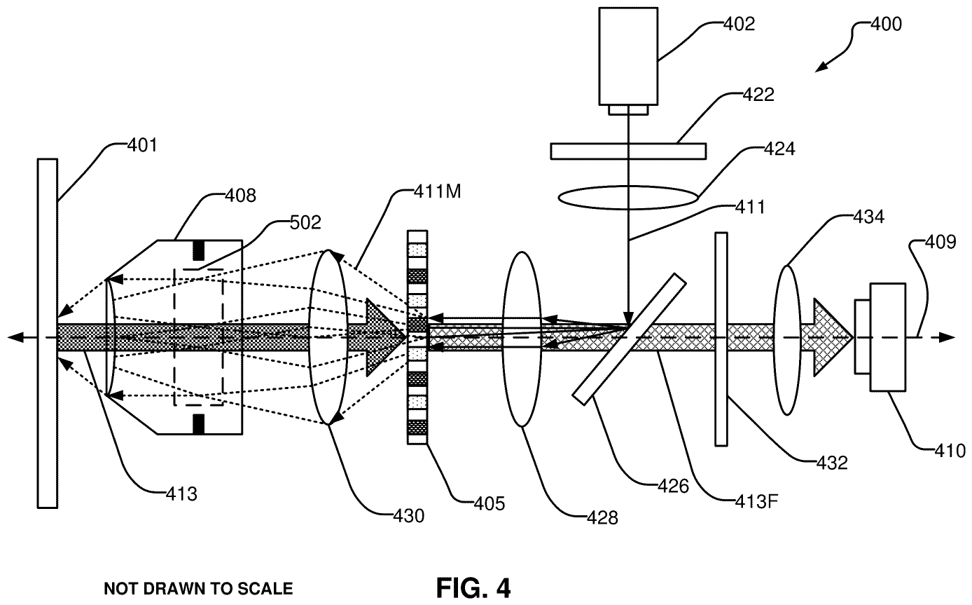

FIG. 4 is a schematic diagram showing an SIM system 400 incorporating a spatial filter which includes a phase-modulating spinnable disk according to any of the embodiments disclosed herein (e.g. disks 200, 300) according to an example embodiment. In many respects, SIM system 400 is similar to SIM system 100 described elsewhere herein and, unless explicitly described as being different or the context indicates a difference, SIM system 400 may comprise any of the features of SIM system 100 and vice versa.

SIM system 400 comprises a light source 402 configured to emit excitation light 411 (illustrated as solid line arrows in FIG. 4). In some embodiments, light source 402 comprises a coherent light source. In some embodiments, light source 402 comprises a laser or lasers. In some embodiments, light source 402 comprises light emitting diodes (LEDs). In some embodiments, excitation light 411 has a wavelength in the range of about 400 nm to 700 nm. In a non-limiting example embodiment, excitation light 411 has a wavelength of about 488 nm.

In an excitation path of system 400, excitation light 411 first passes through a quarter-wave plate 422 configured to polarize (e.g. circularly polarize) excitation light 411. Excitation light 411 is then directed by lens 424 to a beam splitter 426 configured to direct excitation light onto an optical axis 409 of system 400. In some embodiments, beam splitter 426 comprises a dichroic mirror.

Excitation light 411 propagating from beam splitter 426 is directed by a relay lens 428 to a spatial filter 405. Spatial filter 405 may comprise any phase-modulating spinning disk disclosed herein (e.g. disks 200, 300, etc.). Spatial filter 405 is configured to modulate the phase of excitation light 411 to generate phase-modulated excitation light 411M (illustrated as dotted arrows in FIG. 4). In some embodiments, spatial filter 405 modulates the phase of excitation light 411 to introduce a 180° phase shift (phase modulation) or near 180° phase shift (e.g. in a range of 135°-225° or 165°-195° in some embodiments) between light that is transmitted through filter 405 via two different optical paths. In some embodiments, spatial filter 405 modulates the phase of excitation light 411 such that the 0^{th}-order diffraction beam of excitation light 411 is cancelled or at least substantially attenuated in destructive interference as described herein elsewhere.

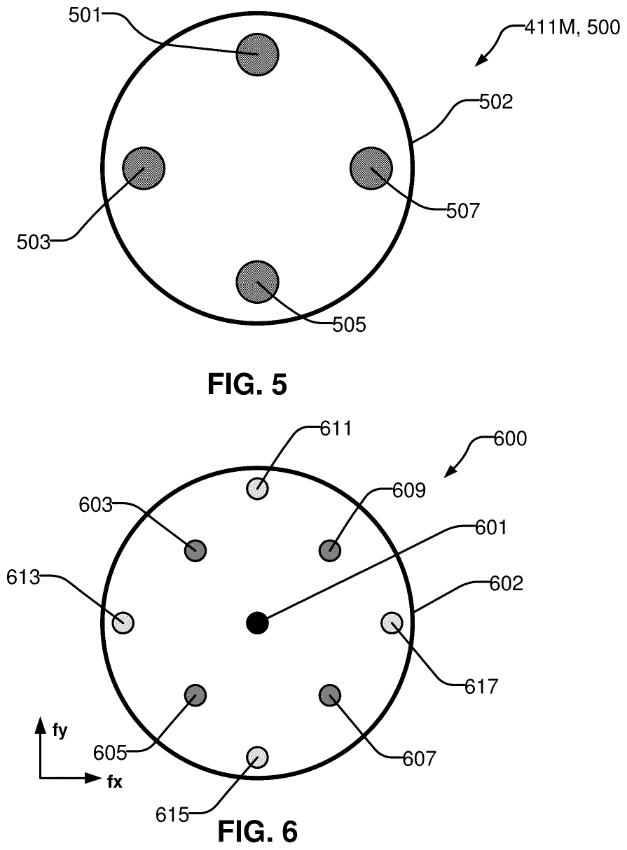

In some embodiments, spatial filter 405 modulates excitation light 411 such that phase-modulated excitation light 411M (FIG. 4) is transmitted from spatial filter 405 as a plurality of (e.g. four) 1^{st}-order diffraction beams. In some embodiments, each of these 1^{st}-order diffraction beams have equal or approximately equal intensity. In some embodiments, spatial filter 405 is located on a focal plane of objective lens 408. FIG. 5 is a schematic diagram of the appearance of phase-modulated excitation light 411M on the plane of a back pupil 500 of objective lens 408 of FIG. 4 according to an example embodiment. Four 1^{st}-order diffraction beams 501, 503, 505 and 507 (illustrated as grey circles in FIG. 5) project within aperture 502 of back pupil 500 of an objective lens and therefore enter objective lens 408 in the pattern shown in FIG. 5. In some embodiments, the four 1^{st}-order diffraction beams 501, 503, 505 and 507 are of equal or approximately equal intensities. Returning to FIG. 4, phase-modulated excitation light 411M is directed by a lens 430 towards an objective lens 408. In some embodiments, lens 430 comprises a tube lens. In a non-limiting example embodiment, lens 430 has a focal length of 300 mm. Objective lens 408 projects phase-modulated excitation light 411M onto target 401. Target 401 may comprise a sample of tissue from an organism, for example.

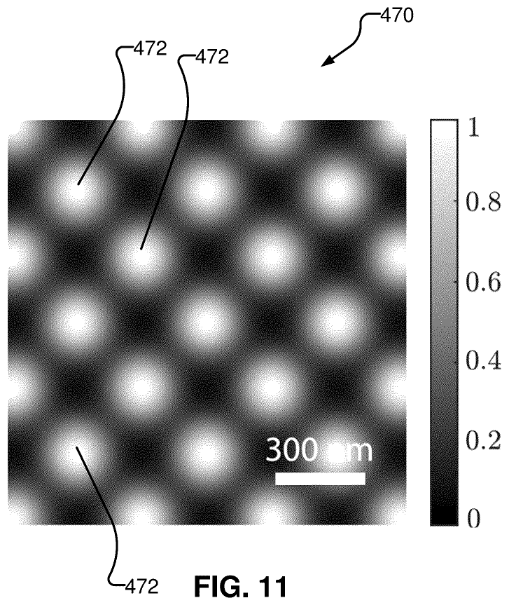

In some embodiments, spatial filter 405 modulates the phase of excitation light 411 such that phase-modulated excitation light 411M forms an interference pattern on target 401. In some embodiments, four 1^{st}-order diffraction beams 501, 503, 505 and 507 interfere to produce a structured illumination pattern (e.g. a lattice illumination pattern comprising a spatially periodic illumination maxima) on a sampling surface of target 401. FIG. 11 is a schematic depiction of a simulation of a portion of the normalized intensity of the lattice pattern 470 generated by SIM system 400 on a sample plane of target 401. In some embodiments, lattice illumination pattern 470 comprises a spatially periodic plurality of illuminating spots 472, each illuminating spot 472 being the result of constructive interference among the 1^{st}-order diffraction beams 501, 503, 505 and 507. In some embodiments, the illuminating spots of the lattice illumination pattern have a size (e.g. at half intensity) that is smaller than the size of spot in diffraction-limited Airy pattern commonly used in instant SIM. The cancellation of the 0^{th}-order beam from phase-modulated excitation light 411M results in a high illumination contrast—in some embodiments, a ratio of maximum (Iₘₐₓ) to minimum illumination (Iₘᵢₙ) is greater that 10 or greater than 12.5.

Returning to FIG. 4, phase-modulated excitation light 411M interacts with target 401 to generate sampled light 413. Sampled light 413 is incoherent. In the collection path of system 400, sampled light 413 is collected by objective lens 408 and then directed by lens 430 back to spatial filter 405. Spatial filter 405 is configured to filter sampled light 413 in the collection path of system 400 to generate filtered sampled light 413F. In some embodiments, spatial filter 405 filters sampled light 413 by rejecting out-of-focus signals of sampled light 413. In some embodiments, spatial filter 405 rejects about 80% of the out-of-focus signals of sampled light 413. In some embodiments, spatial filter 405 comprises a layer (e.g. opaque second layer 323) that is shaped (e.g. by the parameters w and d discussed herein) to filter the out-of-focus signals from sampled light 413 to thereby provide filtered sample light 413F. In some embodiments, sampled light 413 and filtered sample light 413F comprise fluorescent light. In some embodiments, spatial filter 405 comprises a polymer film layer (e.g. third layer 325 described here) wherein the polymer film layer does not affect the fluorescent sampled light 413 because the fluorescent sampled light 413 is not coherent.

In a non-limiting example embodiment, a dimension factor w of spatial filter 405 is about 25 μm and a spatial period parameter d of spatial filter 405 is about 70 μm and an opening ratio is accordingly about 0.35. In some embodiments, the parameters w and d may be selected to provide a smaller opening ratio to filter a greater percentage of the out-of-focus signals from sampled light 413. In some embodiments, the parameters w and d may be selected to provide a larger opening ratio to increase the amount of detected signals and possibly to increase the signal to noise ratio (SNR).

Returning to FIG. 4, filtered sampled light 413F is then directed by relay lens 428 to beam splitter 426. Beam splitter 426 allows filtered sampled light 413F to continue propagating on the collection path of system 400. Filtered sampled light 413F is then further filtered by a filter 432 configured to transmit only a selected range of wavelengths. Filtered sampled light 413F is then directed by relay lens 434 to a light detector 410 configured to collect filtered sampled light 413F. In some embodiments, light detector 410 comprises a camera. In some embodiments, filtered sampled light 413F is processed to generate images. In some embodiments, the images comprise fluorescence images. In some embodiments, SIM system 400 is capable of generating at a frequency greater than 60 Hz. In some embodiments, this image-generating frequency may be greater than 100 Hz or 200 Hz.

Collected filtered sampled light 413F may be further processed by any suitable processing techniques for any suitable purposes. In some embodiments, filtered sample light 413F is processed using, inter alia, a Wiener filtering technique or other suitable noise-reduction technique.

FIG. 6 is a spatial frequency domain view of a Fourier transform 600 of the FIG. 11 lattice (structured illumination) pattern 470 in the fₓ-f_{y} plane produced by systems disclosed herein (e.g. systems 100, 400, etc.) according to an example embodiment.

In FIG. 6, circular boundary 602 in the fₓ-f_{y} plane indicates the cut-off frequency of wide-field microscopy. The FIG. 11 lattice (structured illumination) pattern 470 exhibits nine peaks 601, 603, 605, 607, 609, 611, 613, 615, and 617 in the spatial frequency domain. The nine peaks 601, 603, 605, 607, 609, 611, 613, 615, and 617 shift the object spectrum to nine distinct positions, allowing an objective lens (e.g. objective lens 408) to capture frequencies beyond the diffraction limit of an excitation light (e.g. excitation light 411).

In the non-limiting example embodiment shown in FIG. 6, peak 601 (illustrated as a black spot) has the highest intensity level with a normalized intensity value of 1. Peaks 603, 605, 607 and 609 have the second highest intensity level with normalized intensity values of 0.28. Peaks 611, 613, 615, and 617 have the lowest intensity level with normalized intensity values of 0.08. Therefore, illumination pattern 600 of FIG. 6 achieves a relative peak intensity value ratio of 1:0.28:0.08.

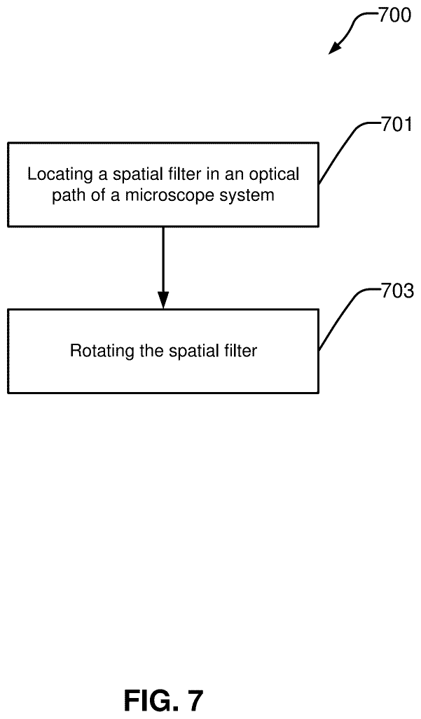

FIG. 7 is a flowchart of a method 700 for confocal microscopy according to an example embodiment. Method 700 may be applied using any systems described herein (e.g. systems 100, 400, etc.)

Method 700 begins with step 701 of locating a spatial filter (e.g. spatial filters 105, 405 described herein) in an optical path of a microscope system (e.g. microscope systems 100, 400 disclosed herein). Method 700 then facilitates confocal microscopy by rotating the spatial filter about a rotating axis that is parallel with the optical path of the microscope system. In some embodiments, the spatial filter is rotated up to 7200 revolutions per minute.

In some embodiments, the spatial filter is configured (as described herein by suitable selection of optical path lengths) to modulate the phase of an excitation light in an excitation path to cause a 180° phase shift or nearly a 180° phase shift (e.g. in a range of 135°-225° or 165°-195° in some embodiments) between excitation light transmitted through a first region of the spatial filter and excitation light transmitted through a second region of the spatial filter. In some embodiments, the spatial filter is configured (as described herein by suitable selection of optical path lengths) such that the 0^{th}-order diffraction beam of the excitation light is cancelled or substantially attenuated. In some embodiments, the spatial filter is configured (as described herein by suitable selection of optical path lengths) to modulate the phase of an excitation light to transmit a plurality of 1^{st}-order diffraction beams of the excitation light. In some embodiments, the plurality of 1^{st}-order diffraction beams comprises four 1^{st}-order diffraction beams. In some embodiments, the spatial filter is configured (e.g. by providing an opaque layer and suitable selection of the parameters d, w) to filter a sampled light in a light collection path. In some embodiments, the spatial filter is configured to reject about 80% of out-of-focus signals in the sampled light in the light collection path.

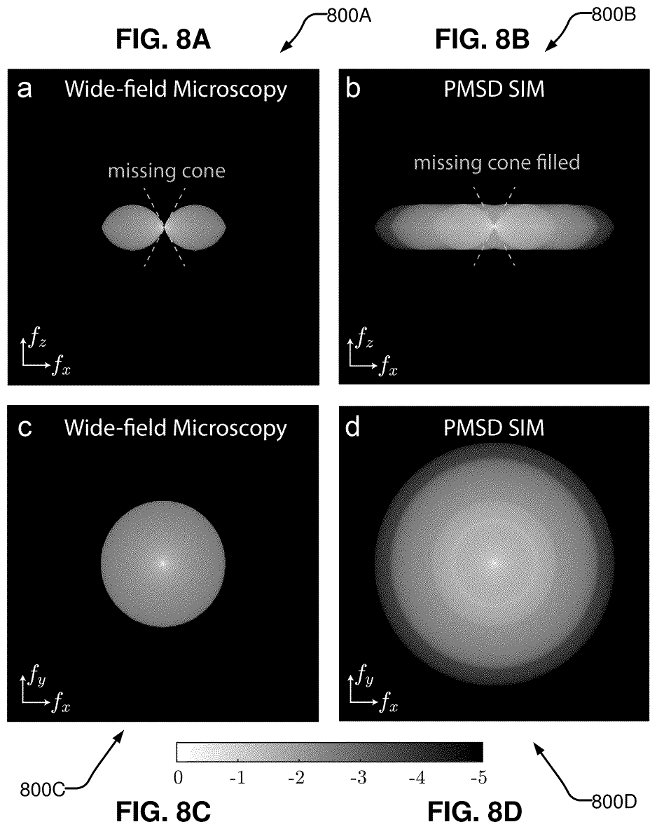

FIG. 8A is an image 800A of an example optical transfer function (OTF) of a wide-field microscopy system in the fₓ-f_{z} plane in the 3D frequency domain when f_{y}=0, where the z-direction is the direction of the optical axis microscope system and the x and y-directions are orthogonal to the optical axis. FIG. 8B is an image 800B of an example OTF of a phase-modulating spinnable disk SIM, such as the microscope system 100 (FIG. 1) or 400 (FIG. 4) described herein (which may be referred to as a “PMSD SIM”) in the fₓ-f_{z} plane in the 3D frequency domain when f_{y}=0, where the z-direction is the direction of the optical axis microscope system and the x and y-directions are orthogonal to the optical axis. FIG. 8C is an image 800C of an example OTF slice of the wide-field microscope system on the fₓ-f_{y} plane when f_{z}=0. FIG. 8D is an image 800D of an example OTF slice of the PMSD SIM on the fₓ-f_{y} plane when f_{z}=0. FIGS. 8A-D are shown in a logarithmic intensity scale with values between 0 and −5.

As can be seen from FIG. 8A, with conventional wide-field microscopy, there is a region of missing frequencies known as the “missing cone”. The missing cone indicates that there is little transmission of axial spatial frequencies through the imaging system. For this reason, conventional wide-field microscopy systems lack optical sectioning capability. FIG. 8B shows the OTF of a PMSD SIM system disclosed herein. As can be seen in FIG. 8B, the “missing cone” is filled, demonstrating the improved optical sectioning capability of PMSD SIM systems disclosed herein.

In the transverse direction (fₓ-f_{y} plane), the PMSD SIM systems expand the cut-off frequency of the OTF by a factor of 2 relative to conventional wide-field microscopy, which is reflected in the difference in size of the substantially circular intensity patterns shown in FIGS. 8C and 8D. The expansion of cut-off frequency may lead to a 2 times increase in the lateral resolution of PMSD SIM systems disclosed herein compared to that of wide-field microscopy.

PMSD SIM systems disclosed herein also have the advantages of being less prone to artifacts compared to conventional SIM systems (e.g. wide-field microscopy systems). A relatively small opening ratio (w/d) can be used to increase the relative intensity of the OTF of the PMSD SIM system at high frequencies at the potential cost of reducing the amount of detected signal and decreased SNR.

Conventional SIM (e.g. wide-field microscopy systems) and 3D SIM require at least 9 raw images for digital reconstruction. Artifacts may appear in the reconstructed image if the sample moves during the image acquisition process. In comparison, PMSD SIM systems as disclosed herein are optically reconstructed in a single exposure. In some embodiments, with a frame rate up to 50 Hz or 100 Hz, artifacts originating from sample motion using PMSD SIM systems as disclosed herein may be greatly reduced relative to conventional wide-field microscopy systems and 3D SIM systems. Additionally, PMSD SIM systems as disclosed herein reduce digital reconstruction errors stemming from distortion of illumination patterns relative to conventional wide-field microscopy systems and 3D SIM systems. As the illumination and excitation pass through the same spatial filter in PMSD SIM systems, distortion in the illumination pattern can be partially compensated. Compared to instant SIM, PMSD SIM systems prevent signal loss due to misalignments of optical components since only one PMSD is used in the PMSD SIM.

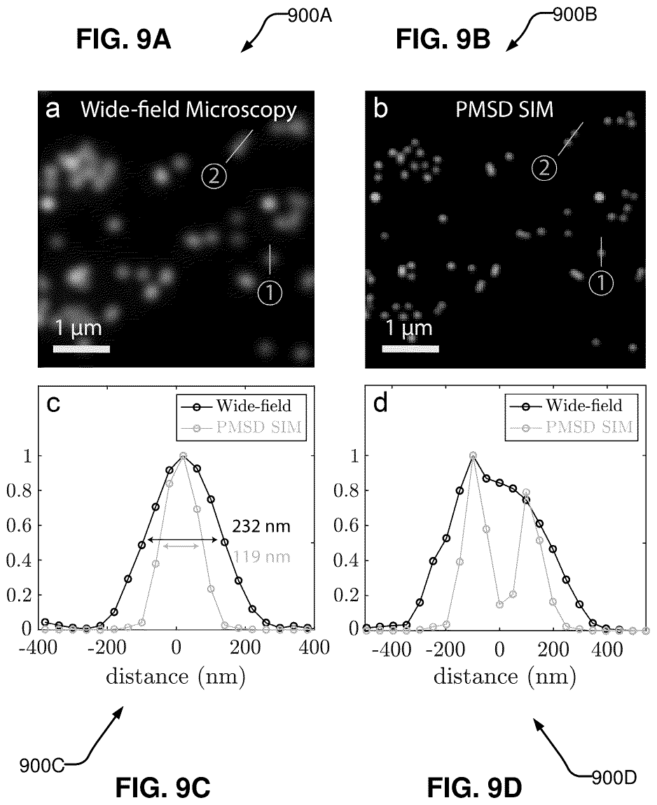

FIG. 9A is an example image 900A of fluorescent beads with a diameter of 100 nm generated by a conventional wide-field microscopy system. FIG. 9B is an example image 900B of fluorescent beads with a diameter of 100 nm generated by PMSD SIM systems disclosed herein (e.g. systems 100, 400, etc.). FIG. 9C is an intensity plot 900C of region 1 shown in FIGS. 9A and 9B. FIG. 9D is an intensity plot 900D of region 2 shown in FIGS. 9A and 9B.

As can be seen in a comparison of FIG. 9A and FIG. 9B, the resolution of the PMSD SIM image is superior to the resolution of the conventional wide-field microscope image. In FIG. 9C, it can be seen from plot 900C that the spatial resolution of the PMSD SIM image is about 2 times more precise than the resolution of the conventional wide-field microscope image. For example, as can be seen in FIG. 9C, in region 1, PMSD SIM reduces the full width at half maximum (FWHM) of the beads from 232 nm to 119 nm. Furthermore, as can be seen in FIG. 9D, in region 2, PMSD SIM is able to distinguish two closely located beads which could not be resolved in the conventional wide-field microscopy.

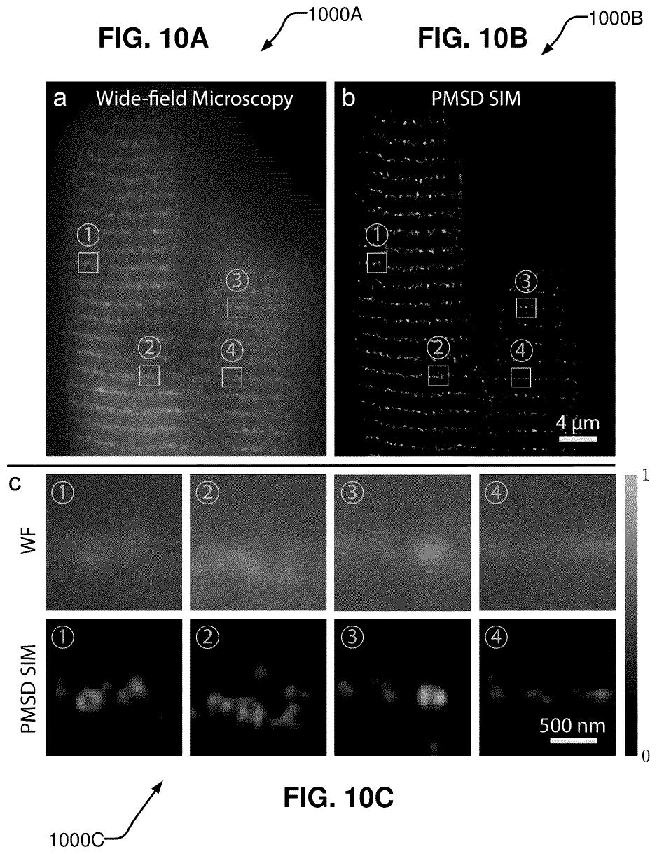

In an experiment conducted by the inventors, cardiac myocytes of rats were used to evaluate the ability of PMSD SIM systems to reduce out-of-focus signals. A typical rat cardiac myocytes has a thickness of 15-20 μm, which is a relatively thick sample. Therefore, imaging by wide-field microscopy produces a notable out-of-focus background. FIG. 10A is an example wide-field microscopy fluorescence image 1000A of ryanodine receptors in a rat cardiac myocytes at a depth of 9 μm. As can be seen from FIG. 10A, the fluorescence image appears hazy and blurry.

On the other hand, PMSD SIM systems are able to significantly reduce the out-of-focus signals for the cardiac myocytes sample. FIG. 10B is an example PMSD SIM fluorescence image 1000B of ryanodine receptors in a rat cardiac myocytes at a depth of 9 μm. As can be seen from FIG. 10B, compared to the wide-field microscopy fluorescence image shown in FIG. 10A, the PMSD SIM fluorescence images provide better contrast and more clearly identify ryanodine receptors that are obscured by background signal in FIG. 10A.

FIG. 10C shows enlarged views 1000C of regions 1-4 shown in FIGS. 10A and 10B. As can be seen from FIG. 10C, in each of regions 1-4, PMSD SIM fluorescence images in FIG. 10B provide better contrast and more clearly identify ryanodine receptors that are obscured by background signal in FIG. 10A.

Systems and methods disclosed herein provide an approach for SIM that increases the contrast for optical sectioning, is less prone to artifacts induced by sample movement and optical imperfections, and is able to be performed at a frequency that enables “real-time” reconstruction of super-resolution images.

Where a component (e.g. a software module, processor, assembly, device, circuit, etc.) is referred to herein, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods as described herein by executing software instructions in a program memory accessible to the processors.

Processing may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, or other data communication channel.

The invention may also be provided in the form of a program product. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

In some embodiments, the invention may be implemented in software. For greater clarity, “software” includes any instructions executed on a processor, and may include (but is not limited to) firmware, resident software, microcode, code for configuring a configurable logic circuit, applications, apps, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Software and other modules may reside on servers, workstations, personal computers, tablet computers, and other devices suitable for the purposes described herein.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
“approximately” when applied to a numerical value means the numerical value ±10%;
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
“first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about”. In this context, “about” provides literal support for the exact numerical value that it precedes, the exact numerical value ±5%, as well as all other numerical values that are near to or approximately equal to that numerical value. Unless otherwise indicated a particular numerical value is included in “about” a specifically recited numerical value where the particular numerical value provides the substantial equivalent of the specifically recited numerical value in the context in which the specifically recited numerical value is presented. For example, a statement that something has the numerical value of “about 10” is to be interpreted as: the set of statements:
in some embodiments the numerical value is 10;
in some embodiments the numerical value is in the range of 9.5 to 10.5;
   and if from the context the person of ordinary skill in the art would understand that values within a certain range are substantially equivalent to 10 because the values with the range would be understood to provide substantially the same result as the value 10 then “about 10” also includes:
in some embodiments the numerical value is in the range of C to D where C and D are respectively lower and upper endpoints of the range that encompasses all of those values that provide a substantial equivalent to the value 10

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention.

Any aspects described above in reference to apparatus may also apply to methods and vice versa.

Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible). This is the case even if features A and B are illustrated in different drawings and/or mentioned in different paragraphs, sections or sentences.

This disclosure provides a number of non-limiting example aspects of the invention. Non-limiting example aspects of the invention comprise:
1. A spatial filter for a confocal microscope, the spatial filter comprising:
   a disk spinnable about a spinning axis in an optical path of the confocal microscope between a coherent light source providing excitation light and a target, the spinnable disk comprising:
   a first region providing a first optical path through the disk, the first region comprising a first optical path length for transmission of the excitation light through the disk;
   a second region providing a second optical path through the disk, the second region comprising a second optical path length for transmission of the excitation light through the disk, the second optical path length different from the first optical path length and thereby imparting a second phase shift to the excitation light transmitted through the second region that is different from a first phase shift imparted to the excitation light transmitted through the first region.
2. The spatial filter of aspect 1 or any other aspect herein, wherein the first region comprises a first index of refraction and the second region comprises a second index of refraction, the second index of refraction different from the fist index of refraction.
3. The spatial filter of any one of aspects 1 to 2 or any other aspect herein, wherein the first region comprises a first geometric path length and the second region comprises a second geometric path length, the second geometric path length different from the first geometric path length.
4. The spatial filter of aspect 1 or any other aspect herein, wherein the first optical path comprises a first effective index of refraction for transmission of the excitation light therethrough and the second optical path comprises a second effective index of refraction for transmission of the excitation light therethrough, the second effective index of refraction different from the first effective index of refraction.
5. The spatial filter of aspect 4 or any other aspect herein, wherein the first effective index of refraction is based on one or more indices of refraction corresponding to one or more portions of the first optical path and the second effective index of refraction is based on one or more indices of refraction corresponding to one or more portions of the second optical path, wherein at least one index of refraction of the one or more indices of refraction of the first optical path is different from at least one index of refraction of the one or more indices of refraction of the second optical path.
6. The spatial filter of any one of aspects 4 to 5 or any other aspect herein wherein the first effective index of refraction is based on one or more geometric path lengths corresponding to one or more portions of the first optical path and the second effective index of refraction is based on one or more geometric path lengths corresponding to one or more portions of the second optical path, wherein at least one geometric path length of the one or more geometric path lengths of the first optical path is different from at least one geometric path length of the one or more geometric path lengths of the second optical path.
7. The spatial filter of any one of aspects 1 to 6 or any other aspect herein wherein the first region is spatially periodic in at least a first direction orthogonal to the spinning axis.
8. The spatial filter of aspect 7 or any other aspect herein wherein the second region is spatially periodic in at least a second direction orthogonal to the spinning axis.
9. The spatial filter of aspect 7 or 8 or any other aspect herein wherein the first region is spatially periodic in a third direction orthogonal to both the spinning axis and the first direction.
10. The spatial filter of aspect 8 or any other aspect herein wherein the second region is spatially periodic in a fourth direction orthogonal to both the spinning axis and the second direction.
11. The spatial filter of aspect 10 or any other aspect herein wherein the first region is spatially periodic in a third direction orthogonal to both the spinning axis and the first direction.
12. The spatial filter of aspect 11 or any other aspect herein wherein the first and second directions are parallel and the third and fourth directions are parallel.
13. The spatial filter of any one of aspects 1 to 12 or any other aspect herein wherein a phase difference between the first phase shift to the excitation light and the second phase shift to the excitation light is in a range of about 135° to about 225°, preferably in a range of 165°-195°, preferably 180°.
14. The spatial filter of aspect 1 to 13 or any other aspect herein wherein a 0^{th}-order diffraction beam of the excitation light transmitted through the disk is cancelled or substantially attenuated due to the phase difference between the first phase shift to the excitation light and the second phase shift to the excitation light.
15. The spatial filter of any one of aspects 1 to 14 or any other aspect herein wherein a plurality of 1^{st}-order diffraction beams of the excitation light is transmitted through the disk to an objective lens of the microscope system.
16. The spatial filter of aspect 15 or any other aspect herein wherein interference of the plurality of 1^{st}-order diffraction beams of the excitation light, after transmission through the objective lens, generates a structured illumination pattern on the target.
17. The spatial filter of aspect 16 or any other aspect herein wherein the structured illumination pattern comprises a lattice illumination pattern comprising spatially periodic illumination maxima.
18. The spatial filter of any one of aspects 1 to 17 or any other aspect herein wherein the first region comprises a plurality of first sub-regions, preferably a spatially periodic plurality of first sub-regions in at least one direction orthogonal to the spinning axis, wherein each first sub-region: provides a corresponding first sub-region optical path through the disk; and has the first optical path length.
19. The spatial filter of aspect 18 or any other aspect herein wherein each first sub-region comprises a corresponding first sub-region pinhole extending through at least one first layer of the disk.
20. The spatial filter of aspect 18 or 19 or any other aspect herein wherein each first sub-region has a shape that is either circular or polygonal in a plane orthogonal to the spinning axis.
21. The spatial filter of any one of aspects 1 to 20 or any other aspect herein wherein the second region comprises a plurality of second sub-regions, preferably a spatially periodic plurality of second sub-regions in at least one direction orthogonal to the spinning axis, wherein each second sub-region: provides a corresponding second sub-region optical path through the disk; and has the second optical path length.
22. The spatial filter of any one of aspects 19 to 20 or any other aspect herein wherein the second region comprises a plurality of second sub-regions, preferably a spatially periodic plurality of second sub-regions in at least one direction orthogonal to the spinning axis, wherein each second sub-region: provides a corresponding second sub-region optical path through the disk; and has the second optical path length.
23. The spatial filter of aspect 22 or any other aspect herein wherein each second sub-region comprises a corresponding second sub-region pinhole extending through the at least one first layer of the disk.
24. The spatial filter of any one of aspects 22 to 23 or any other aspect herein wherein each second sub-region has a shape that is either circular or polygonal in a plane orthogonal to the spinning axis.
25. The spatial filter of any one of aspects 22 to 24 or any other aspect herein wherein a number of second sub-region pinholes equals a number of first sub-region pinholes.
26. The spatial filter of any one of aspects 23 to 25 or any other aspect herein wherein each first sub-region comprises an additional first sub-region pinhole through a second layer of the disk, the second layer of the disk different from the first layer of the disk.
27. The spatial filter of aspect 26 or any other aspect herein wherein the disk comprises a substrate layer transparent to the excitation light from the light source.
28. The spatial filter of aspect 27 or any other aspect herein wherein the substrate layer extends across this disk in directions orthogonal to the spinning axis such that the substrate layer is present in both the first optical path and the second optical path.
29. The spatial filter of aspect 27 or 28 or any other aspect herein wherein the substrate layer comprises an optically flat fused silica substrate.
30. The spatial filter of any one of aspects 27 to 29 or any other aspect herein wherein the first layer is deposited on the substrate layer and is opaque to the excitation light.
31. The spatial filter of aspect 30 or any other aspect herein wherein a ratio of a combined area of the first and second sub-region pinholes in a plane orthogonal to the spinning axis to an area of the first layer in the plane orthogonal to the spinning axis is in a range of: 5%-40%, preferably 10%-30%.
32. The spatial filter of any one of aspects 30 to 31 or any other aspect herein wherein the first layer is made of metal or metal alloy.
33. The spatial filter of any one of aspects 30 to 32 or any other aspect herein wherein the first layer is made of aluminum.
34. The spatial filter of any one of aspects 26 to 33 or any other aspect herein wherein each of the plurality of first sub-regions has a dimension factor w₁ defined by a dimension of the corresponding first sub-region pinhole through the first layer in a plane orthogonal to the spinning axis.
35. The spatial filter of aspect 34 or any other aspect herein wherein each of the plurality of second sub-regions has a dimension factor w₂ defined by a dimension of the corresponding second sub-region pinhole through the first layer in a plane orthogonal to the spinning axis.
36. The spatial filter of any one of aspects 34 to 35 or any other aspect herein wherein the first and second regions have respective spatial periods of d₁ and d₂ in directions orthogonal to the spinning axis.
37. The spatial filter of any one of aspects 34 to 36 or any other aspect herein wherein a plurality of 1^{st}-order diffraction beams of the excitation light is transmitted through the disk to an objective lens of the microscope system and the plurality of 1^{st}-order diffraction beams comprises four 1^{st}-order diffraction beams corresponding to four Fourier peaks of the spatial periodicity of the first and second regions.
38. The spatial filter of aspect 36 or any other aspect herein wherein any adjacent pair of first sub-regions is separated by a distance d₁ in a first direction orthogonal to the spinning axis and any adjacent pair of second sub-region is separated by a distance d₂ in a second direction orthogonal to the spinning axis.
39. The spatial filter of any one of aspects 36 and 38 or any other aspect herein wherein an amount of out-of-focus signals in the sampled light blocked by the first layer is inversely correlated to at least one of: a first opening ratio w₁/d₁; and a second opening ratio w₂/d₂.
40. The spatial filter of aspect 39 or any other aspect herein wherein at least one of the first and second opening ratios is less than 0.5.
41. The spatial filter of any one of aspects 39 to 40 or any other aspect herein wherein an amount of out-of-focus signals in the sampled light blocked by the first layer is greater than 50%.
42. The spatial filter of any one of aspects 26 to 41 or any other aspect herein where the second layer is made of a transparent material having a second layer index of refraction.
43. The spatial filter of aspect 42 where an index of refraction in the additional first sub-region pinholes is different than the second layer index of refraction, thereby imparting a phase shift to the excitation light transmitted through the additional first sub-region pinholes that is different from a phase shift imparted to the excitation light transmitted through the second layer.
44. The spatial filter of aspect 43 or any other aspect herein wherein each first sub-region is defined at least in part by a corresponding additional first sub-region pinhole through the second layer and a corresponding first sub-region pinhole through the first layer to provide the first optical path.
45. The spatial filter of aspect 43 or 44 or any other aspect herein wherein each second sub-region is defined at least in part by a corresponding portion of the second layer and a corresponding second sub-region pinhole through the first layer to provide the second optical path.
46. The spatial filter of any one of aspects 42 to 45 or any other aspect herein wherein the second layer is made of a material from one or more of: film polymer or liquid crystal.
47. The spatial filter according to any one of aspects 1 to 46 or any other aspect herein wherein the disk is locatable in the optical path of the confocal microscope wherein the spinning axis is co-axial with an optical axis of the microscope.
48. The spatial filter according to any one of aspects 1 to 47 or any other aspect herein wherein the disk is locatable on a focal plane of the objective lens of the confocal microscope.
49. A spatial filter for a confocal microscope, the spatial filter comprising:
   a spinnable disk locatable for spinning about a spinning axis in an optical path of the confocal microscope between a coherent light source and a target, the spinnable disk comprising:
   a first region providing a first optical path through the disk the first region comprising a corresponding first effective index of refraction;
   a second region providing a second optical path through the disk the second region comprising a corresponding second effective index of refraction different from the first effective index of refraction;
   wherein the first and second regions modulate the phase of light transmitted through the disk.
50. The spatial filter of aspect 49 comprising any features, combinations and/or sub-combinations of features of any other aspect herein.
51. A method for confocal microscopy, the method comprising:
   locating the spatial filter of any one of the aspects herein in the optical path of a microscope system between a coherent light source and a target; and
   spinning the disk about a spinning axis that is coaxial with an optical axis of the microscope.
52. The method of aspect 51 or any other aspect herein, wherein the microscope system comprises an objective lens and the disk is located on a focal plane of the objective lens.
53. The method of any one of aspects 51 and 52 comprising method steps comprising any feature, combination of features or sub-combination of features of any other aspect herein.
54. A spinnable disk confocal microscope comprising any feature, combination of features and/or sub-combination of features of the spatial filter of any other aspect herein.
55. A spatial filter for a microscopy system comprising:
a spinning disk, the disk comprising:
   a substrate;
   a first layer deposited on the substrate, wherein the first layer comprises a plurality of pinholes; and,
   a second layer deposited on the first layer, wherein the second layer comprises a film material having properties that affect the phase of transmitted light, and wherein the second layer is deposited on the first layer in an arrangement that causes the light transmitted through the disk to undergo a phase modulation.
56. The spatial filter of aspect 55 or any other aspect herein, wherein the phase modulation comprises a 180° phase shift.
57. The spatial filter of aspect 55 or any other aspect herein, wherein the phase modulation comprises a cancellation of 0^{th}-order light.
58. The spatial filter of aspect 55 or any other aspect herein, wherein the phase modulation creates a 2D lattice illumination pattern produced by an interference of four first-order light beams.
59. The spatial filter of aspect 55 or any other aspect herein, wherein the disk is integrated into a wide-field microscopy system comprising an objective lens with a focal plane, and wherein the disk is positioned in the focal plane.
60. The spatial filter of aspect 55 or any other aspect herein, wherein the first layer can be of any material that changes the transmission of light, including but not limited to, metals, such as aluminum, gold, and silver, and non-metals, such as liquid crystals, and polarization-sensitive polymers.
61. The spatial filter of aspect 55 or any other aspect herein, wherein the substrate and the first layer can be combined into one piece to produce one metal disk with pinholes.
62. The spatial filter of aspect 55 or any other aspect herein, wherein the pinholes are polygonal or circular.
63. The spatial filter of aspect 55 or any other aspect herein, wherein the pinholes are triangles, squares, hexagons, octagons or decagons.
64. The spatial filter of aspect 55 or any other aspect herein, wherein the distance between each pinhole in the plurality of pinholes creates an interference pattern on a sample.
65. The spatial filter of aspect 55 or any other aspect herein, wherein the surface area of the plurality of pinholes comprises 0%-99% of a disk surface area.
66. The spatial filter of aspect 55 or any other aspect herein, wherein the surface area of the plurality of pinholes comprises 50%-99% of a disk surface area.
67. The spatial filter of aspect 55 or any other aspect herein, wherein the surface area of the plurality of pinholes comprises 80% of a disk surface area.
68. The spatial filter of aspect 55 or any other aspect herein, wherein the second layer modulates the phase of light on a sample.
69. The spatial filter of aspect 55 or any other aspect herein, wherein the second layer produces an illumination pattern on a sample.
70. The spatial filter of aspect 55 or any other aspect herein, wherein the second layer comprises a polymer or liquid crystal.
71. The spatial filter of aspect 55 or any other aspect herein, wherein the second layer is transparent, or nearly transparent.
72. The spatial filter of aspect 55 or any other aspect herein, wherein the second layer covers 40%-60% of the pinholes in the plurality of pinholes.
73. A method for fabricating a spinning disk for a spatial filter, the method comprising:
   coating a layer of photoresist on the optically flat fused silica substrate;
   curing the photoresist by patterned light using a photomask, or by maskless photolithography;
   developing the photoresist using a developer solution;
   depositing an aluminum layer onto the substrate by physical vapor deposition;
   removing the exposed photoresist, and the aluminum deposited on the exposed photoresist, creating pinholes;
   coating a layer of photoresist on the aluminum layer;
   curing the photoresist by patterned light using a photomask, or by maskless photolithography;
   developing the photoresist using a developer solution;
   removing the exposed photoresist, and the film material deposited on the exposed photoresist, creating pinholes.
74. The method of aspect 73, wherein coating at least portion of the aluminum layer with the film material comprises coating every other pinhole in the plurality of pinholes with the film material.
75. Apparatus having any new and inventive feature, combination of features, or sub-combination of features as described herein.
76. Methods having any new and inventive steps, acts, combination of steps and/or acts or sub-combination of steps and/or acts as described herein.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

What is claimed is:

1. A spatial filter for a confocal microscope, the spatial filter comprising:
a disk spinnable about a spinning axis in an optical path of the confocal microscope between a coherent light source providing excitation light and a target, the spinnable disk comprising:
a first region providing a first optical path through the disk, the first region comprising a first optical path length for transmission of the excitation light through the disk;
a second region providing a second optical path through the disk, the second region comprising a second optical path length for transmission of the excitation light through the disk, the second optical path length different from the first optical path length and thereby imparting a second phase shift to the excitation light transmitted through the second region that is different from a first phase shift imparted to the excitation light transmitted through the first region.

2. The spatial filter of claim 1, wherein the first region comprises a first index of refraction and the second region comprises a second index of refraction, the second index of refraction different from the fist index of refraction.

3. The spatial filter of claim 1, wherein the first region comprises a first geometric path length and the second region comprises a second geometric path length, the second geometric path length different from the first geometric path length.

4. The spatial filter of claim 1, wherein the first optical path comprises a first effective index of refraction for transmission of the excitation light therethrough and the second optical path comprises a second effective index of refraction for transmission of the excitation light therethrough, the second effective index of refraction different from the first effective index of refraction.

5. The spatial filter of claim 4, wherein the first effective index of refraction is based on one or more indices of refraction corresponding to one or more portions of the first optical path and the second effective index of refraction is based on one or more indices of refraction corresponding to one or more portions of the second optical path, wherein at least one index of refraction of the one or more indices of refraction of the first optical path is different from at least one index of refraction of the one or more indices of refraction of the second optical path.

6. The spatial filter of claim 4 wherein the first effective index of refraction is based on one or more geometric path lengths corresponding to one or more portions of the first optical path and the second effective index of refraction is based on one or more geometric path lengths corresponding to one or more portions of the second optical path, wherein at least one geometric path length of the one or more geometric path lengths of the first optical path is different from at least one geometric path length of the one or more geometric path lengths of the second optical path.

7. The spatial filter of claim 1 wherein the first region is spatially periodic in at least a first direction orthogonal to the spinning axis.

8. The spatial filter of claim 7 wherein the second region is spatially periodic in at least a second direction orthogonal to the spinning axis.

9. The spatial filter of claim 7 wherein the first region is spatially periodic in a third direction orthogonal to both the spinning axis and the first direction.

10. The spatial filter of claim 8 wherein the second region is spatially periodic in a fourth direction orthogonal to both the spinning axis and the second direction.

11. The spatial filter of 10 wherein the first region is spatially periodic in a third direction orthogonal to both the spinning axis and the first direction.

12. The spatial filter of claim 11 wherein the first and second directions are parallel and the third and fourth directions are parallel.

13. The spatial filter of claim 1 wherein a phase difference between the first phase shift to the excitation light and the second phase shift to the excitation light is in a range of about 135° to about 225°, preferably in a range of 165°-195°, preferably 180°.

14. The spatial filter of claim 1 wherein a 0^{th}-order diffraction beam of the excitation light transmitted through the disk is cancelled or substantially attenuated due to the phase difference between the first phase shift to the excitation light and the second phase shift to the excitation light.

15. The spatial filter of claim 1 wherein a plurality of 1^{st}-order diffraction beams of the excitation light is transmitted through the disk to an objective lens of the microscope system.

16. The spatial filter of claim 15 wherein interference of the plurality of 1^{st}-order diffraction beams of the excitation light, after transmission through the objective lens, generates a structured illumination pattern on the target.

17. The spatial filter of claim 16 wherein the structured illumination pattern comprises a lattice illumination pattern comprising spatially periodic illumination maxima.

18. The spatial filter of claim 1 wherein the first region comprises a plurality of first sub-regions, preferably a spatially periodic plurality of first sub-regions in at least one direction orthogonal to the spinning axis, wherein each first sub-region: provides a corresponding first sub-region optical path through the disk; and has the first optical path length.

19. The spatial filter of claim 18 wherein each first sub-region comprises a corresponding first sub-region pinhole extending through at least one first layer of the disk.

20. The spatial filter of claim 18 wherein each first sub-region has a shape that is either circular or polygonal in a plane orthogonal to the spinning axis.
